(19) United States
(12) Patent Application Publication
(10) Pub. No.: US 2015/0377780 A1
(43) Pub. Date: Dec. 31, 2015

(54) PLASMONIC PROJECTED DIFFRACTION SENSOR

(71) Applicant: INTEGRATED PLASMONICS CORPORATION, San Francisco, CA (US)

(72) Inventors: Robert Joseph Walters, San Francisco, CA (US); Francisco Richard LePort, San Francisco, CA (US)

(73) Assignee: Integrated Plasmonics Corporation, San Francisco, CA (US)

(21) Appl. No.: 14/766,551

(22) PCT Filed: Dec. 3, 2013
(86) PCT No.: PCT/US2013/072930

§ 371 Date: Aug. 7, 2015

Related U.S. Application Data
(60) Provisional application No. 61/785,400, filed on Mar. 14, 2013.
(60) Provisional application No. 61/762,818, filed on Feb. 8, 2013.

(51) Int. Cl. G01N 21/552; G01N 21/47

(52) U.S. Cl. CPC G01N 21/554; G01N 21/4788; G01N 2201/062

(57) ABSTRACT

A device for detecting an analyte includes a light source emitting substantially monochromatic light; a two-dimensional diffraction element that interacts with the light from the light source, the diffraction element having one or more features that can generate plasmon waves upon receipt of the light from the light source, at least some of the features being configured to interact with the analyte; and a two-dimensional image sensor facing the diffraction element to receive diffracted light from the diffraction element so as to detect a diffraction pattern projected thereto and to measure a two-dimensional spatial change in the diffraction pattern that occurs as a result of the analyte interacting with the feature of the diffraction element.

### BACKGROUND

1. Field of the Invention

The present disclosure relates to instrumentation and methods relying on surface plasmonic interactions for enabling biological and chemical sensing capable of detecting minute quantities of biological or chemical substances.

2. Description of the Related Art

Surface plasmons are collective oscillations of conduction electrons, which can exist at the physical interface of metal and dielectric media. Surface plasmons can be excited by optical waves under certain conditions. Resonant coupling occurs between the optical field and the surface plasmons and results in an increase or decrease in the intensity of the optical field strength. Surface plasmon interactions have been used as detection elements in various sensor systems.

One type of sensor system that uses surface plasmon interactions is a surface plasmon resonance (SPR) biosensor of the type manufactured by Biacore, formerly a Swedish company, now a division of GE Healthcare. The SPR biosensor of this type can detect chemical and biological events on a metal surface through detecting changes in refractive index resulting from the chemical and biological events on the metal surface. The operating principle involves use of the attenuated total reflectance method. An optical field is introduced into an optical prism having a thin metal layer deposited on a surface associated with the base of the prism. When introduced to the surface, light evanescently interacts with the metal film and excites a surface plasmon at the outer boundary of the metal film. When the incident optical field is polychromatic, significant coupling occurs only for a narrow band of wavelengths and the spectrum of the optical field strength reflected from a metal surface where it may create a surface plasmon resonance contains a characteristic spectral feature, typically a dip. The wavelength of the SPR dip is sensitive to changes in the refractive index of the medium in which the surface plasmon resonance propagates. Therefore, very small changes in the refractive index at the surface of the metal film can be measured by monitoring the position or wavelength of the SPR dip. The binding of analyte molecules to biorecognition elements immobilized on the surface of the metal film, if properly designed, causes a change in the refractive index in the vicinity of the surface of the metal film, and as a result, creates a shift in the wavelength of a dip in the reflected field strength due to SPR coupling. The change in the resonance wavelength can be correlated with the concentration and/or type of analyte. When monochromatic light is used, the plasmon resonance can be observed as a sharp drop in the reflected light at an angle that is dependent on the refractive index in the vicinity of the surface. Therefore, the arrival or capturing of the analyte molecules can be detected by detecting a shift in the angle at which the resonance is observed.

SPR sensors are used across many fields. In food quality and safety, SPR sensors have been used to detect bacteria, such as Escherichia coli and Salmonella Enteritidis. SPR sensors can also detect drug residues, hormones, allergens, proteins, chemical contaminants, and toxins produced by bacteria. For medical diagnostics, antibodies, drugs, hormones, and disease biomarkers can be identified or monitored with SPR. SPR sensors are also used to detect the presence of pesticides and heavy metals in the environment.

In recent years, industries and academia have been making significant efforts towards development of technologies and infrastructures suitable for distributed diagnostics and home healthcare. One well-known, successful exemplary device in this endeavor is a portable glucose automonitoring device that can monitor the glucose level of the user by sampling of blood taken from a fingertip. Many efforts have been devoted to developing similar portable devices that can measure other biochemical substances. In this regime, what is needed from instrumental points of view is not high-precision, versatile measurement instruments that can detect a wide range of target analytes/substances with great accuracy, such as Biacore systems, but low-cost, portable devices that can detect certain defined groups of target analytes/substances reliably and conveniently for the purpose of monitoring and diagnosing the users' physiological and biomedical conditions.

Unfortunately, the conventional SPR sensor systems typically include expensive and complex optical components such as prism couplers, diffraction gratings, optical fibers, and integrated optical waveguides. These SPR sensor systems are often maintained in centralized laboratories to facilitate sharing. Monitoring immediate changes in environmental or health-related conditions is generally impracticable. Moreover, conventional SPR sensor systems are generally too large for immediate and mobile use. Furthermore, the cost per assay is very high, and therefore, they are inadequate for self-monitoring of the biochemical substances, which is required for distributed diagnostics and home healthcare.

### SUMMARY OF THE INVENTION

In light of the above and in view of a general trend for portable and personal monitoring of biochemical substances in the users, there exists a need for a system and method suitable for implementation in cost-efficient and reliable devices for distributed diagnostics and personal or home healthcare.

An object of the present invention is to solve one or more of problems or disadvantages of existing sensor technologies, certain aspects of which are described above.

Another object of the present invention is to provide a portable and cost-efficient device for self-monitoring of a biochemical substances taken from the user.

Another object of the present invention is to provide a cost-efficient and reliable device for detecting changes in refractive index that result from attachments of target substance to a detection site.

Another object of the present invention is to provide a disposable, portable device that is suited for distributed diagnostics and home or personal healthcare.

Another object of the present invention is to provide simple and cost-efficient methods and processes for detecting biochemical substances suitable for distributed diagnostics and home or personal healthcare or the like.

Another object of the present invention is to provide a cost-efficient and reliable method for manufacturing a device for detecting changes in refractive index that result from attachments of target substance to a detection site.

Another object of the present invention is to provide a portable and disposable unit for measuring target substances, such as blood cells in blood taken from the user, which can be connected to a host device for analysis and data recording.

To achieve one or more of these and other advantages and in accordance with the purpose of the present invention, as embodied and broadly described, in one aspect, the present invention provides a device for detecting an analyte, the device including: a light source emitting substantially monochromatic light; a two-dimensional diffraction element that interacts with the light from the light source, the diffraction element having one or more of features that can generate plasmon waves upon receipt of the light from the light source, at least some of the features being configured to interact with the analyte; and a two-dimensional image sensor configured to receive diffracted light from the diffraction element so as to detect a diffraction pattern projected thereto and to measure a two-dimensional spatial change in the diffraction pattern that occurs as a result of the analyte interacting with the feature of the diffraction element.

In another aspect, the present invention provides a method for detecting an analyte, including: emitting substantially monochromatic light; diffracting said light with a two-dimensional diffraction element, said light being coupled to one or more of features of the diffraction element to generate plasmon waves; causing at least a portion of the diffraction element to interact with an analyte; and detecting a diffraction pattern projected by the diffracted light on a two-dimensional image sensor and measuring a two-dimensional spatial change in the diffraction pattern on the image sensor that occurs as a result of the analyte interacting with the feature of the diffraction element.

In another aspect, the present invention provides a device for detecting a target substance in a solution, the device having the following features:

a light source that emits substantially monochromatic light;

a container configured to contain a solution that contains one or more types of target substances, said solution having a refractive index different from a refractive index of said one or more types of target substances;

a substantially planar diffraction element optically coupled to the light source to receive the light originating from the light source, the diffraction element having a top surface and a bottom surface and having one or more of openings that are empty or filled with a dielectric wherein said openings generate plasmon waves upon receipt of the light from the light source, the top surface of the diffraction element being configured to interact with the solution in the container and configured to attach surface-immobilized receptors in the vicinity thereon that will bind said one or more types of target substances in the solution so that a change in refractive index occurs in the vicinity of said top surface when the target substance binds to said surface immobilized receptors;

a two-dimensional image sensor disposed under the diffraction element to detect a diffraction pattern projected onto the image sensor by the light from the light source that has interacted with the diffraction element, the image sensor having a plurality of pixels to detect the diffraction pattern; and

a processor connected to the two dimensional image sensor to process signals outputted from the sensor for determining the presence of the target substance on the diffraction element,

wherein the diffraction element and the image sensor are configured and arranged such that, upon receipt of the light from the light source, the plasmon waves are generated on the diffraction element so as to generate the diffraction pattern that includes a plurality of distinct diffraction spots or lines on the image sensor, positions of the plurality of distinct diffraction spots or lines on the image sensor being dependent on the refractive index in the vicinity of the top surface of the diffraction element.

In another aspect, the present invention provides a multi-detection system for detecting a target substance or substances in a solution. The multi-detection system includes a plurality of the devices as described immediately above, wherein a single container and a single image sensor are shared among the plurality of the devices as the container and the image sensor, respectively, of the respective devices.

In another aspect, the present invention provides a portable projected diffraction device including the following features:

a housing enclosing the multi-detection system as set forth immediately above, the housing having a recess to receive the solution containing target substances therein, the housing further having a fluid channel communicating with the recess and with the single container to transport the solution to the container;

a circuit board housed by the housing, the circuit board including a processor shared among the plurality of devices as the processor of respective one of the plurality of devices;

one or more of light emitting devices and an optical system optically coupled to said one or more of light emitting devices as the light sources of the plurality of devices; and

a connector configured to be connected to a host device, the connector being connected to the circuit board for energizing the circuit board and for exchanging data with the host device.

In another aspect, the present invention provides a method of manufacturing a device that detects a target material in a solution, the method including:

depositing a dielectric layer on an array of photodetectors constituting a two-dimensional image sensor;

forming a metal layer on the dielectric layer;

forming a diffraction element in the metal layer;

forming an enclosure on the diffraction element for containing the solution that includes the target, the enclosure being configured so that the diffraction element interacts with the solution when the enclosure is filled with the solution; and

providing a light source that emits substantially monochromatic light optically coupled to the diffraction element,

wherein the diffraction element has one or more of features that can generate plasmon waves upon receipt of the light form the light source, at least some of the features being configured to interact with the target substance, and

wherein the two-dimensional image sensor receives diffracted light from the diffraction element so as to detect a diffraction pattern projected thereto and to measure a two-dimensional spatial change in the diffraction pattern that occurs as a result of the substance interacting with the feature of the diffraction element.

In another aspect, the present invention provides a portable projected diffraction unit to be attached to a host device that has an external light source, the unit including:

a housing with a connector for connecting the unit to the host device;

a container housed by said housing, configured to contain a solution that contains one or more types of target substances, said solution having a refractive index different from a refractive index of said one or more types of target substances;

a plurality of substantially planar diffraction elements housed by said housing, each of the diffraction elements being configured to be optically coupled to the external light source in the host device to receive light originating from the external light source when connected to the host device, each of the diffraction elements having a top surface and a bottom surface and having one or more of openings that are empty or filled with a dielectric, wherein said openings generate plasmon waves upon receipt of the light from the external light source, the top surface of each of the diffraction elements being configured to interact with the solution in the container and configured to attach surface-immobilized receptors in the vicinity thereon that will bind said one or more types of target substances in the solution so that a change in refractive index occurs in the vicinity of said top surface when the target substance binds to said surface-immobilized receptors;

a two-dimensional image sensor housed by said housing and disposed under the plurality of diffraction elements to detect respective diffraction patterns projected onto the image sensor by the light that has interacted with the diffraction elements, the image sensor having a plurality of pixels to detect the diffraction patterns; and

a circuit board connected to the two dimensional image sensor to process signals outputted from the sensor to transmit the processed signals to the host device through the connector when the unit is connected to the host device, so that the host device can further process the signals,

wherein said housing has a recess to receive the solution containing the target substances therein, the housing further having a fluid channel communicating with the recess and with the single container to transport the solution to the container.

According to at least some of these aspects of the present invention, commercial products embodying the present invention can be manufactured cost-effectively and reliably using relatively inexpensive materials and components with relatively simple manufacturing methods. Thus, commercial products of the present embodiment and any other embodiments of the present invention described below can be made to be disposable, when appropriate, each for single use only, for example. This is one of the significant advantages over the existing technologies owing to the simple and economical nature of the configuration of various embodiments of the present invention.

Additional features and advantages of the invention will be set forth in the description which follows and in part will be apparent from the description, or may be learned by practice of the embodiments of the invention disclosed herein. The other objectives and advantages of the invention will be realized and attained by the structure particularly pointed out in the written description and claims hereof and/or in the appended drawings.

It is to be understood that both the foregoing general description and the following detailed description are exemplary and explanatory, and are intended to provide further explanation of the invention as claimed in a patent(s) originating from this application.

### BRIEF DESCRIPTION OF THE SEVERAL VIEWS OF THE DRAWINGS

FIGS. 1A and 1B schematically illustrate a projection diffraction device.

FIGS. 2A and 2B show a pattern on a diffraction element and projected diffraction pattern, respectively, according to one embodiment.

FIG. 2C shows the intensity of the light received by an image sensor taken along the X-axis of FIG. 2B.

FIGS. 3A and 3B show a pattern on a diffraction element and projected diffraction pattern, respectively, according to one embodiment.

FIG. 3C shows the intensity of the light received by an image sensor taken along the X-axis of FIG. 3B.

FIGS. 4A-4F respectively show examples of patterns on a diffraction element.

FIGS. 5A-5C and 6A-6C respectively show examples of shapes of each opening that may constitute patterns on a diffraction element.

FIGS. 7A-7D respectively show various examples of a diffraction element.

FIG. 8 schematically illustrates a multi-detection system for detecting an analyte or analytes.

FIGS. 9A and 9B schematically show examples of arrangement of the diffraction element and the image sensor.

FIGS. 10A and 10B schematically illustrate surface-immobilized receptors on the top surface of the diffraction element.

FIG. 11 schematically illustrates an embodiment of a multi-detection system for detecting an analyte or analytes.

FIGS. 12A and 12B schematically illustrate a portable projected diffraction device having a plug connector. FIG. 12A is a top view and FIG. 12B is a cross-sectional view taken along the line XII-XII of FIG. 12A.

FIGS. 13A and 13B respectively show a pattern on a diffraction element and a projected diffraction pattern.

FIG. 13C shows the intensity of the light received by an image sensor taken along the X-axis of FIG. 13B.

FIG. 14 is an equal intensity contour plot of the diffraction pattern of FIG. 13B.

FIGS. 15A and 15B show a pattern on a diffraction element and projected diffraction pattern, respectively, according to one embodiment.

FIG. 15C is an equal intensity contour plot of the diffraction pattern of FIG. 15B.

### DETAILED DESCRIPTION

Embodiments are described in detail with reference to the drawings. Features and structures contained in attached drawings are schematic representations of embodiments of the present invention and are not drawn to scale; relative dimensions of the features and structures depicted are not accurate. In particular, for ease of explanation and illustration, even in the same drawings, some of the features or structures are exaggerated or magnified by one or more orders of magnitude as compared with other features of the drawings.

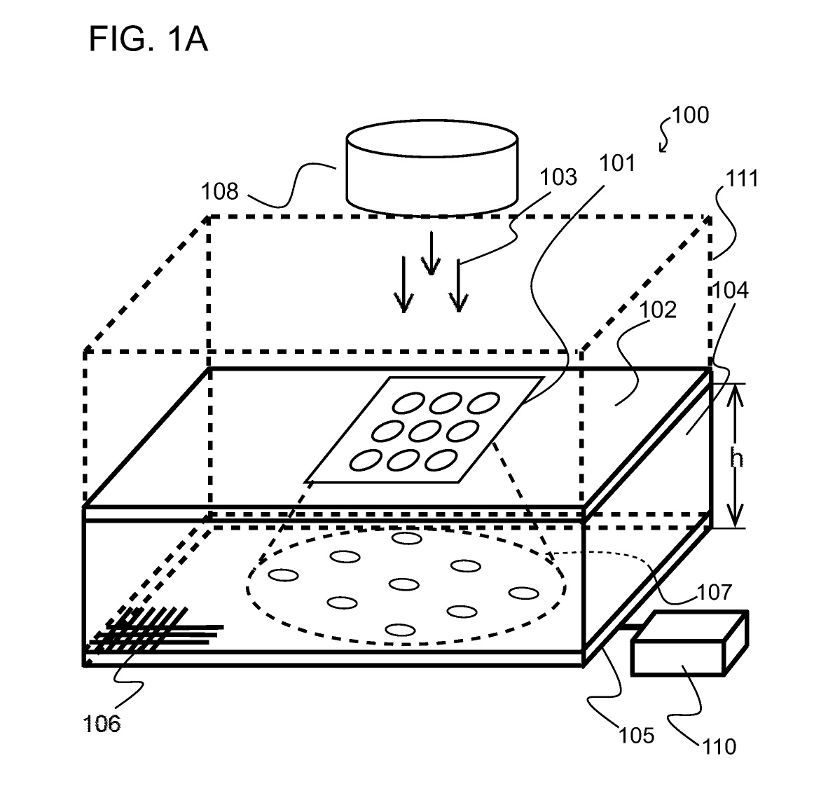

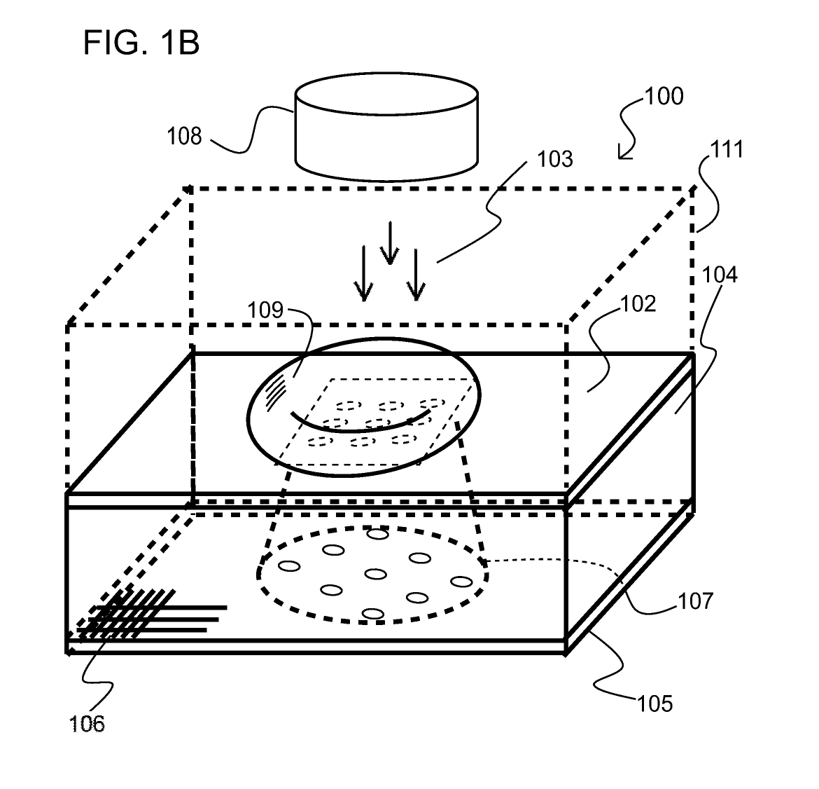

FIGS. 1A and 1B schematically illustrate a compact, low-cost projected diffraction device 100 according to one embodiment. The device 100 is designed to detect the presence of specific chemical analytes (target substances) by monitoring changes in refractive index caused by the presence of the analyte. FIG. 1A shows a configuration of the device 100 when target substance 109 is absent, and FIG. 1B shows the same when the target substance 109 arrived at a detection site.

Referring to FIG. 1A, the device 100 includes: a light source 108 emitting substantially monochromatic light 103; a container 111 capable of holding a solution that includes one or more types of target substances/analytes; a diffraction element 101 in a metal layer 102 that interacts with the light from the light source and projects a diffraction image therebelow; a dielectric layer 104; and an image sensor 105 for detecting the diffraction pattern projected thereto. Processor 110 is provided to process signals from the image sensor 105.

The container 111 can be formed in whole or in part of a material substantially transparent to the light 103 emitted from the light source 108 so that the light 103 interacts with the diffraction element 101 in the metal layer 12. Although the container 111 has a structure adequate to contain the solution with the target substances therein, it is drawn by dotted lines to show structures underneath clearly.

The light source 108 includes a light emitting device, which can include but is not limited to a laser diode, a light emitting diode (LED) or a vertical cavity surface emitting laser (VCSEL). In addition, an optical filter and/or collimating optical system may be included in the light source 108. A polarizer or polarizing optical system may be included in the light source 108 or separately provided below the light source 108. The resulting direct or filtered light interacts with the diffraction element 101. The light source 108 preferably emits substantially monochromatic light with a certain degree of coherence. The degree of the coherence and the bandwidth of the emitted light should be such that the diffraction pattern projected onto the image sensor (which will be described in detail below) exhibits sufficient key features to be recognized by the image sensor for the diffraction element used. With an appropriately designed diffraction element and an image sensor having a sufficiently dense pixel array, a semiconductor solid-state LED having a center wavelength in visible or near-infrared light with band width of a few tens of nanometers may be used as the light source 108 or as the light emitting device to be included in the light source 108 together with other optical components. A laser diode having a narrower bandwidth with higher coherence may also be used.

In this embodiment, the light 103 from the light source 108 is incident upon the container 111 in a direction substantially normal to a plane defined by the diffraction element 101.

In this embodiment, the diffraction element 101 is structured to have one or more of openings that are empty or filled with a dielectric in the metal layer 102 so that plasmon waves are generated upon receipt of the light from the light source 108. That is, the openings of the diffraction element 101 are the features that can generate or otherwise launch plasmon waves. The plasmon waves are sensitive to the refractive index of the environment in the immediate vicinity of the surface of the diffraction element 101. Thus, the resulting diffraction pattern projected onto the image sensor 105 changes its shape when the refractive index in the vicinity of the diffraction element 101 changes. The bottom of the container 111 is constituted at least in part of the metal layer 102 or diffraction element 101 so that the surface of the diffraction element 101 is in contact with the solution in the container 111. Because the target substance 109 has a refractive index that differs from the refractive index of the solution, when the target substance 109 in the solution is attached or associated to the diffraction element 101 (see FIG. 1B), the refractive index in the vicinity of the diffraction element 101 changes, and the change in refractive index is in turn detectable by a spatial position shift, for example, of the diffraction pattern projected onto the image sensor 105.

When the opening is to be filled with a dielectric, the dielectric can be made of silicon oxide or any other material transparent to the incident light, for example. The metal layer 102 is made of a material that can support at least some generation and propagation of plasmon waves, such as aluminum, copper, ruthenium, rhodium, palladium, silver, osmium, iridium, platinum, and gold, or any alloy thereof as well as any other suitable conductive and reflective material or the like.

In this embodiment, a two-dimensional spatial change in the diffraction pattern 107 that results from the change in refractive index is measured by the image sensor 105 having numerous pixels 106. For some combinations of the target substance 109 and diffraction elements, the spatial pattern change may be an expansion or contraction of the overall two-dimensional diffraction pattern projected onto the image sensor 105 in the ratio roughly proportional to the change in the refractive index. FIG. 1B schematically illustrates in an exaggerated manner a shrinkage of the diffraction pattern 107 in response to the arrival of the target substance 109 as an example.

Furthermore, the diffraction element 101 and the image sensor 105 may be configured and arranged such that the resulting diffraction pattern 107 on the image sensor 105 exhibits a plurality of distinct diffraction spots or lines so that the pattern change can be readily detected and recognized by a relatively inexpensive image sensor having a sufficient spatial resolution.

Whether spots or lines are adequately distinct depends on the spatial resolution and the intensity resolution of the image sensor 105. For example, when a relatively simple image sensor having a low-intensity resolution, but a high pixel density, is used, spots or lines may be determined to be sufficiently distinct when the pixels of the image sensor register more than about 30% intensity drop over a few pixels or a few tens of pixels across darker areas between the adjacent spots or lines. When an image sensor with a high intensity resolution is used, a much smaller change in the intensity of the received light can be recognized as distinct spots or lines. In determining these intensity variations, a bright spot(s) that is not much affected by the refractive index change of interest (typically a bright spot at the center of the diffraction pattern) may be disregarded by ignoring pixels detecting the bright spot(s) (or allowing such pixels to saturate), by adjusting the range of the intensities each pixel can resolve, and/or by adjusting the gain or exposure time. Alternatively, such a spot(s) may be blocked by a light shielding pattern formed on the image sensor, for example. Alternatively, the image sensor (or multiple image sensors) may be placed such that only select features of the diffraction pattern are detected. These distinct spots or lines may constitute key features of the diffraction pattern, which can be used to identify the pattern and detect small changes in the pattern. For example, an overall arrangement of respective peak positions of the key features can be detected and recognized using a relatively simple data processor and algorithm for pattern recognition. Relative positions among a plurality of select features in the diffraction pattern (like spots or lines) can be detected and the changes thereof can be evaluated to determine the presence or absence of the target substance 109.

The diffraction element and the light source may also be configured such that a diffraction pattern formed by a plurality of distinct diffraction spots or lines change anisotropically in response to a change in the refractive index on the diffraction element. For example, in some areas of the diffraction pattern, the spots or lines may shift outwardly towards the periphery of the image sensor, and in other areas, the sports or lines may shift inwardly towards the center of the diffraction pattern. In another example, the contraction/expansion ratio of a pattern formed by the plurality of distinct diffraction spots or lines can be made to be different between one axis and another axis on the image sensor Linearly polarized light and/or a diffraction element having particular directional features, for example, can generate such anisotropy in the diffraction pattern. The resulting anisotropy can be detected by the image sensor and utilized by the processor to increase the accuracy and reliability of the detection of the target substance, for example.

The device can also be configurable such that a particular refractive index change promotes or eliminates certain surface plasmon polariton modes so that drastic changes in the pattern itself appear in the diffraction pattern when the target substance is present or absent on the detection site.

In this embodiment, substantially monochromatic light 103 may have a central wavelength of 300 nm to 1100 nm, for example. Diffraction element 101 may have a detection site, which comprises structures supporting resonances or propagating modes that are sensitive to a refractive index change, in lateral dimensions in the range of a few microns to 50 microns, for example. An example of the detection site is depicted by the rectangular box 101 indicated in FIG. 1A. The distance h between the diffraction element 101 and the image sensor 105 may be 0.05 mm to 10 mm, for example, to ensure development of the diffraction pattern on the image sensor and to allow expansion of the pattern so as to provide better spatial sensitivity on the image sensor.

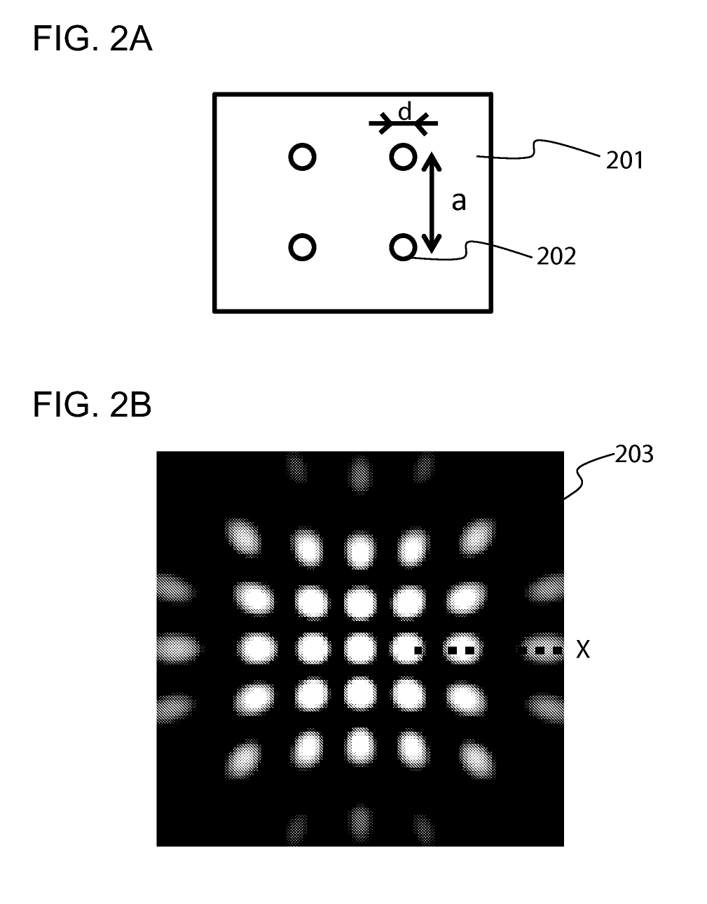

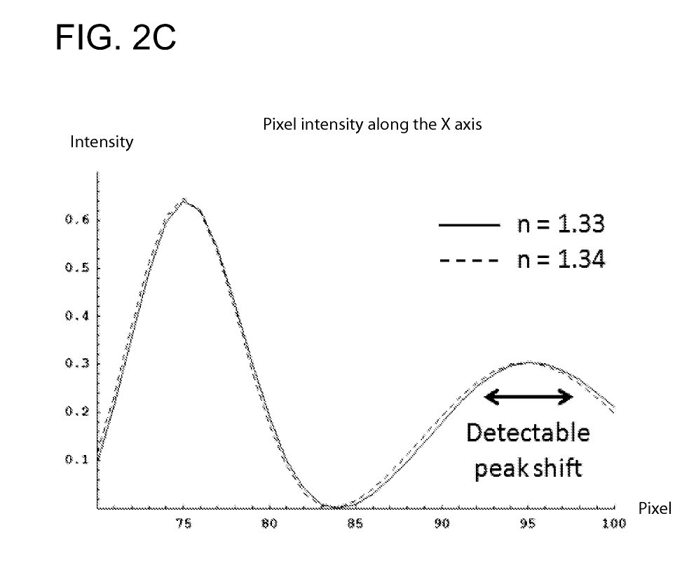

To further illustrate operational principles, a simulation was conducted using an exemplary diffraction element with a setup conceptually identical to that depicted in FIG. 1A. FIG. 2A shows the pattern of openings in the diffraction element 101 used in the simulation. FIG. 2B shows the resulting projected diffraction pattern. The projected diffraction pattern of FIG. 2B was obtained using Finite-Difference Time-Domain (FDTD) numerical simulation.

As shown in FIG. 2A, in this example, diffraction element (detection site) 201 has four circular holes 202 penetrating a silver film with the thickness of 70 nm. The diameter d of each hole was set to 150 nm, and the spacing a of the holes was set to 2 microns.

In the simulation, the incident light was a plane wave with a wavelength of 600 nm polarized linearly in the horizontal direction. The image sensor for simulation purposes had 100×100 pixels in a square detection surface of dimensions of 1 mm×1 mm. The refractive index of the dielectric layer was set to 1 for simulation purposes. The simulated image sensor was placed 1 mm below the diffraction element 201. Since the small holes can efficiently couple optical fields to plasmon waves at the surface of the silver film, plasmon waves significantly contribute to generation of the diffraction pattern under this setting. FIG. 2B shows the resulting diffraction pattern 203 when the refractive index above the diffraction element 201 is 1.33.

As shown in FIG. 2A, the diffraction pattern 203 shows a plurality of substantially symmetrically placed distinct diffraction spots spreading over the almost entire detection area of the image sensor. Also, slightly enhanced peaks are visible due to the linear polarization of the incident light.

FIG. 2C shows the intensities of the light received by the simulated image sensor taken along the X-axis of FIG. 2B in the range of pixel numbers 70 to 100. The bold line shows the results when the refractive index is 1.33 and the dotted line shows the results when the refractive index is 1.34. As shown in FIG. 2C, the change in the refractive index produces detectable shifts in peak positions. Although mere 100×100 pixels are used for simulation purposes, corresponding to a spatial resolution of 10 microns, many currently available inexpensive image sensors, such as CMOS camera chips, have a much higher spatial resolution and comprise millions of pixels. For example, for a given set of the target substance and the solution, the pixel pitch of the image sensor can be selected so that at least one of the diffraction spots or lines in the diffraction pattern shifts its position by a distance large enough to facilitate data processing in the determination of the presence or absence of the target substance.

Therefore, it was confirmed that changes in refractive index in the order of 1% or slightly less can be readily detected using the configuration of the present embodiment depicted in FIGS. 1A and 1B and using a relatively inexpensive CMOS camera chip or the like. By appropriately designing various dimensions of the device and the pattern of the diffraction element 201, it is possible to detect a much smaller change in the refractive index.

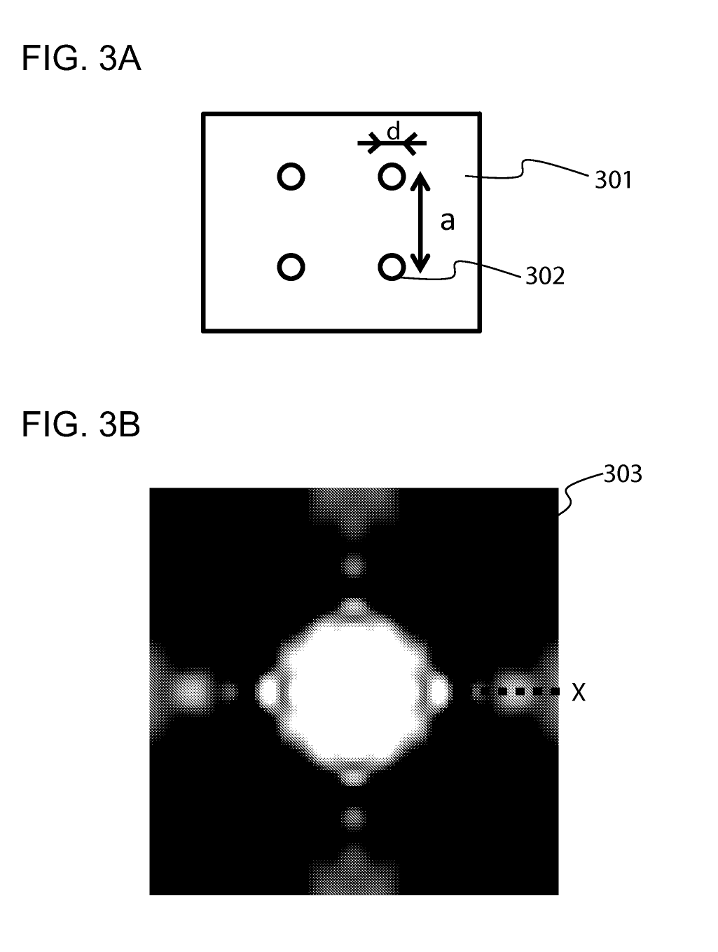

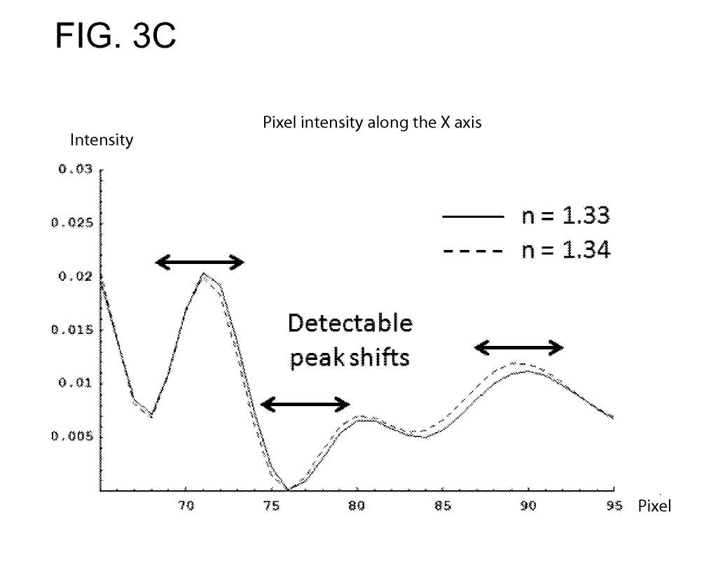

FIGS. 3A and 3B show another embodiment of the diffraction element 301 of FIGS. 1A and 1B 1 and the resulting projected diffraction pattern, respectively, using the same simulation conditions and scheme as those for FIGS. 2A and 2B. FIG. 3C shows the intensity of the light received by an image sensor taken along the X-axis of FIG. 3B. As shown in FIG. 3A, this diffraction element (detection site) 301 has four holes 302, but the diameter d of each hole and the hole spacing a differ from those of FIG. 2A. The diameter d of the hole was set to 300 nm, and the spacing a was set to 0.5 microns. The other parameters are the same as those of the above example. As shown in FIG. 3C, detectable peak shifts are observed from the data.

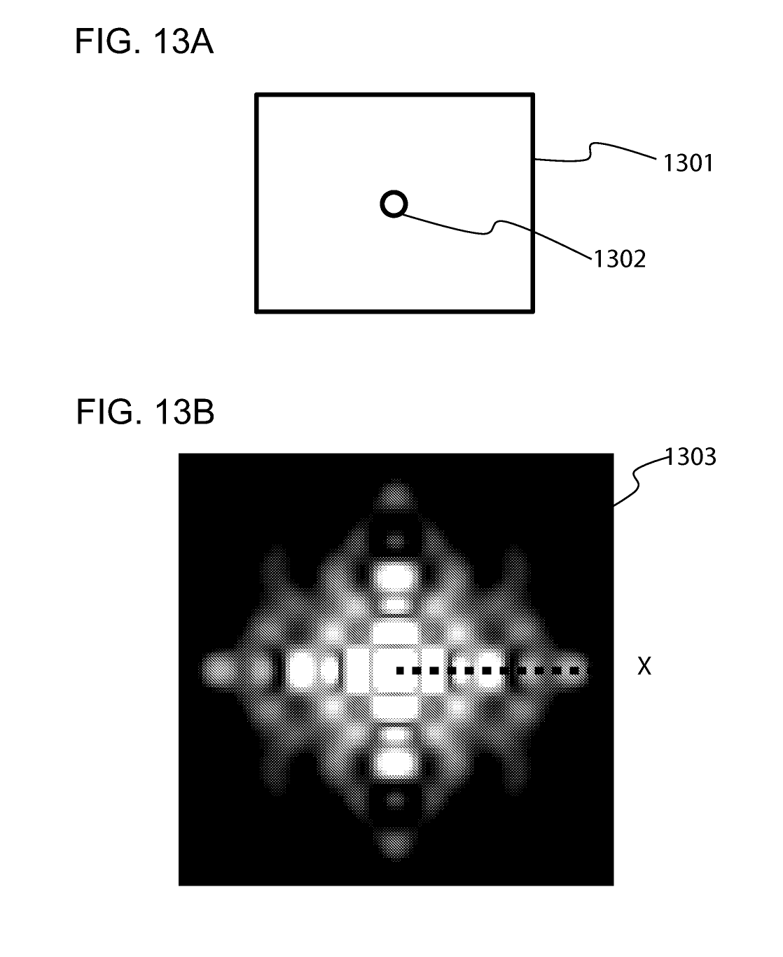

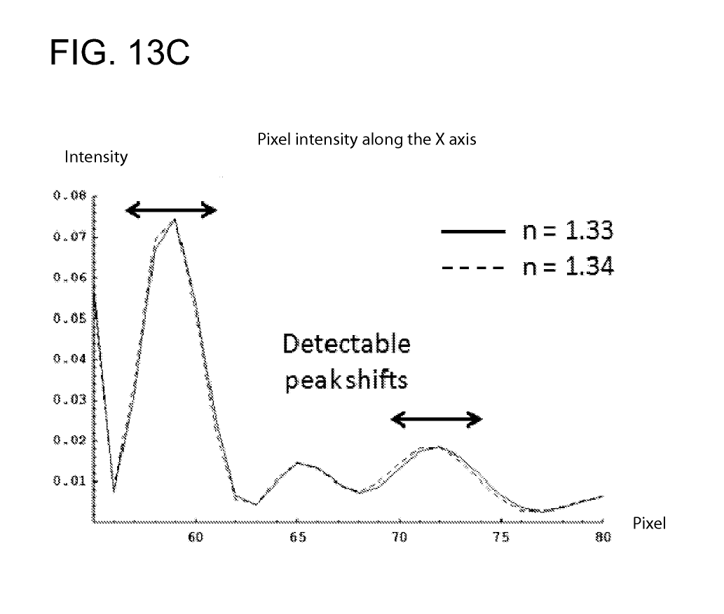

FIGS. 13A and 13B show another embodiment of the diffraction element 1301 of FIGS. 1A and 1B and the resulting projected diffraction pattern 1303, respectively, using the same simulation conditions and scheme as those for FIGS. 2A and 2B. FIG. 13C shows the intensity of the light received by an image sensor taken along the X-axis of FIG. 13B. As shown in the figures, this diffraction element (detection site) 1301 has a single hole 1302 instead of four holes as shown in the above examples. The diameter of the hole was set to 300 nm. The other parameters are the same as those of the above example. As shown in FIG. 13C, while peak shifts are smaller than the data shown in FIG. 2C, detectable peak shifts are observed from the data.

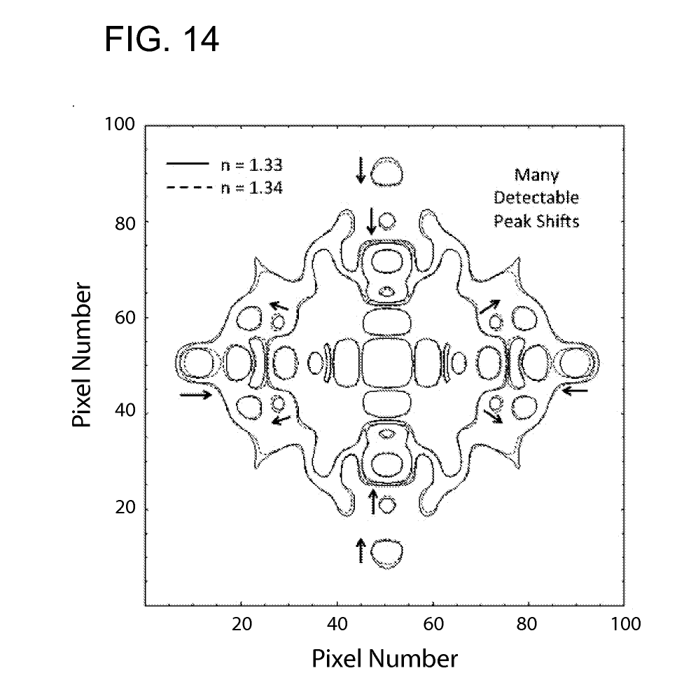

FIG. 14 shows an intensity contour plot of the diffraction pattern of FIG. 13B. The solid lines indicate a set of equal-intensity contour lines for the refractive index of 1.33, and the dotted lines indicate the same set of equal-intensity contour lines when the refractive index was changed to 1.34. As shown in the plot, many detectable peak shifts are observed across a wide area of the image sensor. Furthermore, as shown by the arrows in the figure, some features of the diffraction pattern shift inwardly toward the center of the diffraction pattern, and other features of the diffraction pattern shift outwardly towards the periphery of the image sensor, indicating that the two-dimensional pattern change is anisotropic. The position shifts of these multiple features of the diffraction pattern can be utilized to achieve a sensitive and reliable detection of the refractive index change—thus, the presence or absence (and partial presence) of the target substance. Returning to FIGS. 1A and 1B, in this embodiment, the change in the diffraction pattern is detected by the image sensor 105 having numerous pixels 106. Specifically, a processor 110 is connected to the image sensor 105 to process signals from the image sensor so that the processor 110 can determine the change in the diffraction pattern and—hence, the presence/absence and/or partial presence of the target substance. The processor 110 controls the image sensor and performs acquisition of data from the image sensor, normalization of data, removal of image artifacts such as hot or dark pixels, subtraction of dark current and other low level data processing, packetization of data, which may include conditions used for data acquisition. Alternatively, the processor 110 may be designed to conduct only portions of the signal processing and control, such as A/D conversion and addressing, and may forward the processed data to a host computer/device for further processing for the determination of the pattern change and the presence of the target substance. The processor 110 may be equipped with user programmable Flash memory, EPROM or like memory to store software for executing pre-installed algorithms to perform the data processing. In addition, drivers or other circuitries are provided to drive the image sensor 105 and the light source 108 and to extract signals representing the light intensity received at the image sensor.

Various data processing methods can be used to process signals from the image sensor 105. For example, the processor or the host computer connected to the processor may use a single threshold to determine the presence or absence of the target substance on the surface when a relatively large change in refractive index is to be detected.

The processor or the host computer may process the data to detect a pattern formed by at least some of the plurality of distinct diffraction spots or lines in the diffraction pattern, and determines the presence or absence of the target substance in accordance with a two-dimensional spatial change in the pattern. Furthermore, alternatively or in addition, the processor or the host computer may use a subpixel interpolation algorithm to determine two-dimensional coordinates representing a position of at least one of a plurality of distinct diffraction spots or lines when the diffraction pattern contain such a plurality of distinct diffraction spots or lines. The processor or the host computer may use a subpixel interpolation algorithm to determine two-dimensional coordinates representing respective peak positions of a plurality of distinct diffraction spots or lines at a resolution greater than a resolution of the image sensor, and may detect a pattern formed by the determined peak positions of the plurality of distinct diffraction spots or lines using a pattern recognition algorithm, and the processor or the host computer then may determine the presence or absence or partial presence of the target substance in accordance with a two-dimensional spatial change in the pattern.

As shown above, the present embodiment has a configuration in which the light from the light source passes through the container containing the solution/target substances. Therefore, certain undesirable scattering of the light may occur. This may adversely affect detection, due to a possible reduction in the signal-to-noise (S/N) ratio of the signals generated by the image sensor 105. To improve the S/N ratio and detection, if necessary, various techniques can be employed.

When a particular design for the pattern and openings is adopted for the diffraction element 101, the resulting diffraction pattern can be numerically calculated or empirically determined using reference samples. Also, for a given set of solution and target substance, the two-dimensional spatial change in the diffraction pattern, such as a magnification or contraction factor, can be numerically calculated or empirically determined using reference samples. Thus, for example, the processor or the host computer may use known data fitting techniques, such as the least squares fitting, to recognize the diffraction pattern and the change in the pattern using a small number of the parameters to fit the diffraction pattern. In another example, the device may additionally include an optical modulator that modulates at least one of the phase, polarization, and intensity of the light emitted from the light source, and the processor or the host computer may demodulate the signals from the image sensor to improve the S/N ratio. Quasi-random sequence modulation and frequency modulations used in the lock-in detection schemes are examples of such modulation. A pulse modulation with a pulse train of a prescribed pulse frequency or other forms of the intensity modulation and use of circularly polarized incident light with a prescribed frequency are other examples of the applicable modulation.

In the embodiment shown in FIG. 1A, the square area 101 (i.e., the diffraction element 101) corresponds to a detection site where the presence or absence of the target substance can be detected. When the target substance covers only partially the detection site 101 of the diffraction element, the processor or the host computer connected to the processor may be configured to process the signals from the image sensor 105 to determine a fractional occupancy condition at which the target substance occupies the detection site. This can be achieved by having the processor recognize the two-dimensional spatial change in the diffraction pattern that occurs as a result of the partial coverage. Various data processing schemes and algorithms described above can be utilized to process the signals for this purpose.

Certain embodiments can be manufactured at low cost using commercially available and relatively inexpensive CMOS camera chips. For example, an inexpensive CMOS chip can be processed to strip surface layers, such as a lens layer and a color filter layer deposited on the top of the CMOS chip to expose the photodetection area. This can be done on a wafer level before die separation. Alternatively, an intermediate wafer product with no deposited lenses or color filters extracted from a commercial production line of CMOS chips can be used for this purpose. Thereafter, a dielectric layer 104 can be formed by a known technique, such as PVD, followed by deposition of a metal layer 102 for the formation of the diffraction element 101. Vacuum evaporation, sputtering, or other known methods can be used to form the metal layer on the dielectric layer 104. The holes (or any other design pattern) in the metal layer can be drilled by a Focused Ion Beam (FIB) apparatus, lithographic methods, such as liftoff lithography, nanoprint lithography, dip pen nanolithography, standard photolithography, x-ray lithography, electron beam direct lithography, or other appropriate methods to form the diffraction element 101. The holes can be empty, or alternatively, can be filled with a dielectric by depositing a dielectric layer on the patterned metal layer.

The container 111 may be formed on the metal layer 102 using any solid material that can hold the solution therein and that is transparent to the incoming light 103. For example, it may be made from polymer by molding and/or machining. Laser machining, mechanical drilling, powder blasting, waterjet cutting, injection molding, hot embossing, and/or polymer casting, etc., can be used. Other appropriate materials for the container 111 include silica, quartz, and silicon, for example. Micromachining technique or other techniques can be used to form the side walls and the top surface of the container 111 first, and then the machined container structure can be bonded on the metal layer 102 with an appropriate adhesive to complete the construction of the container 111. Advantageously, since the device can be made inexpensively, devices such as disclosed herein can be made to be disposable—each for single use only. This is one of the significant advantages over the existing technology due to the simple and economical nature of the configuration and the detection schemes of various embodiments of the present invention.

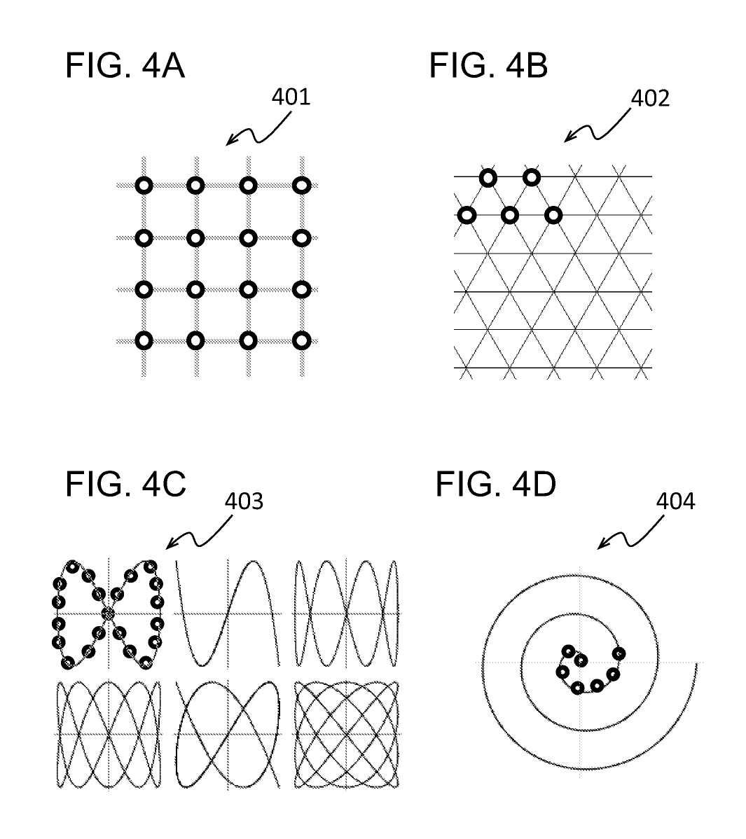

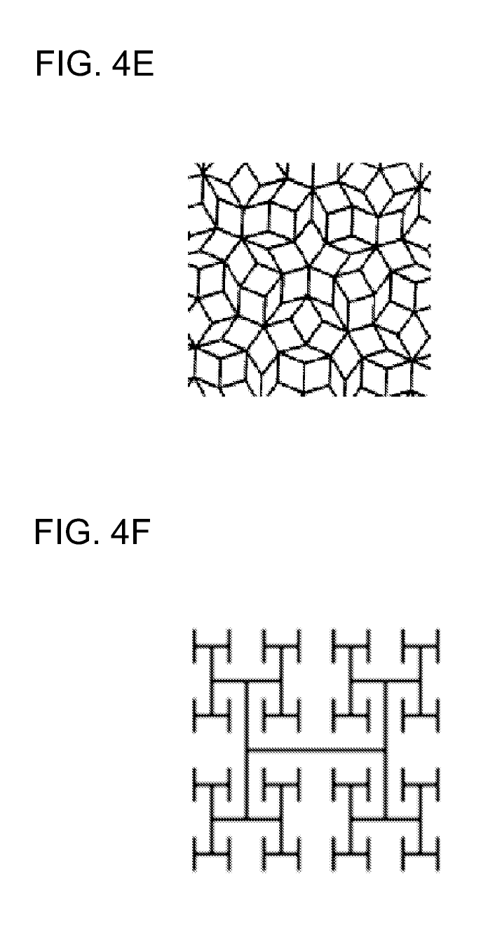

FIGS. 4A-4F respectively show examples of patterns of the diffraction element that can be used in any embodiments. As shown in FIGS. 4A and 4B, the holes can be arranged in the lattice points of a periodic pattern such as a square lattice or a triangular lattice. The holes can also be placed so as to follow the constituent lines of any of Lissajous curves some of which are shown in FIG. 4C, or can be placed to follow a spiral curve shown in FIG. 4D. FIG. 4E is another example of the pattern of the diffraction element and shows a Penrose tile. FIG. 4F is an H-fractal pattern that can be used in any of embodiments. Other periodical, quasi-periodical, self-similar, fractal, and aperiodical patterns are usable. Instead of holes placed in representative points of these patterns, penetrating openings that follow constituent lines of these patterns can be formed. Dimension of the holes/openings and dimensions of the patterns are appropriately chosen so that the resulting two-dimensional change in the diffraction pattern as a result of the presence of the target substance can be recognized by the image sensor.

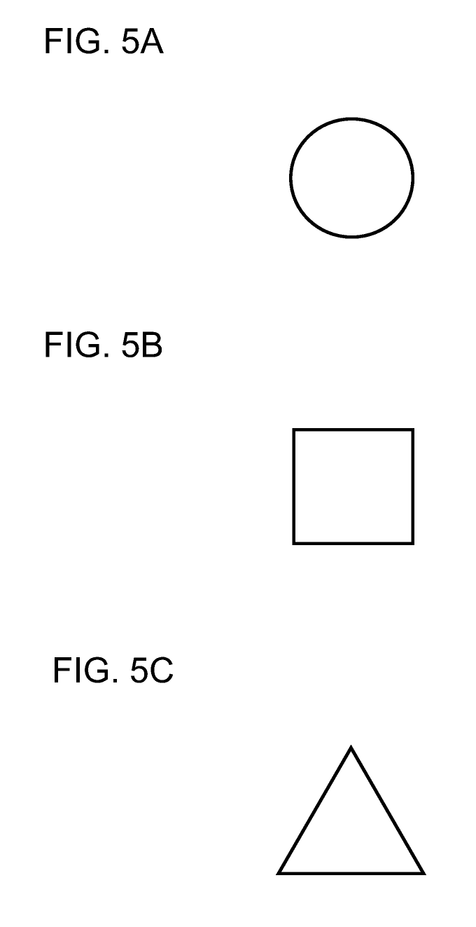

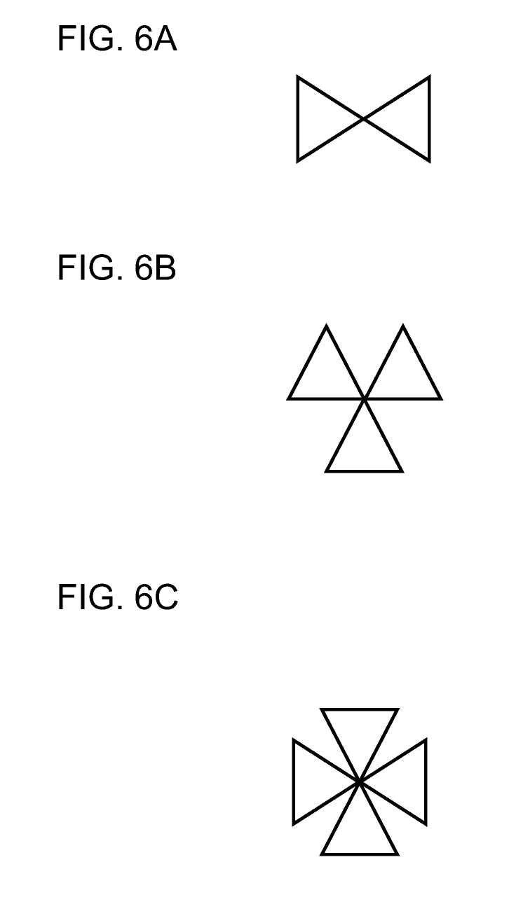

FIGS. 5A-5C and 6A-6C respectively show examples of the shape of each of the openings that constitute patterns on a diffraction element. Instead of the circular hole described above and shown in FIG. 5A, a square hole shown in FIG. 5B, a triangular hole shown in FIG. 5C, or other opening shapes shown in FIGS. 6A-6C having certain rotational or line symmetry can be appropriately used.

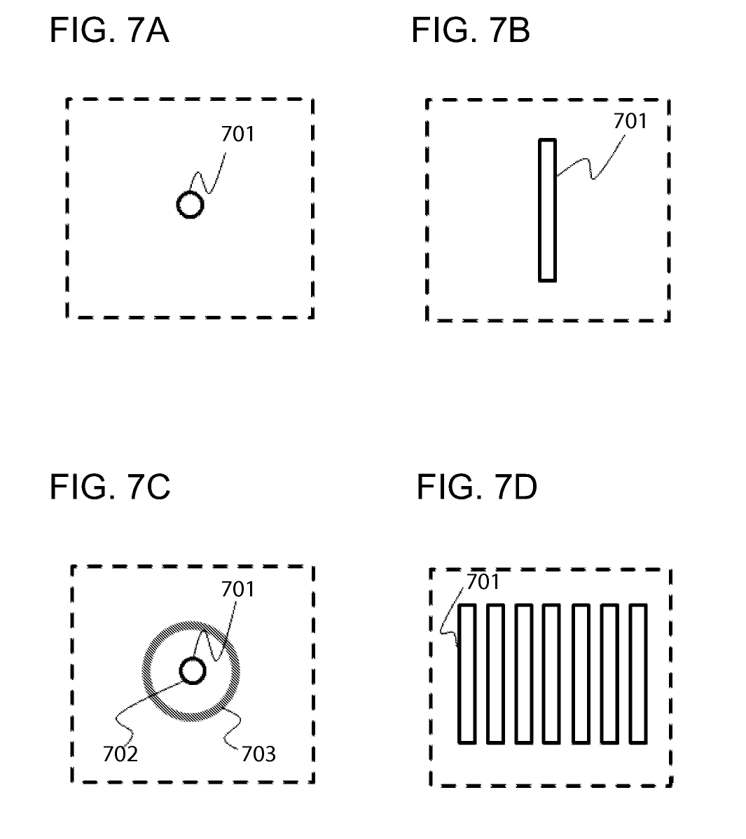

FIGS. 7A-7D show examples of the diffraction element. In addition to the patterns/features described above, such as a single hole 701 in a metal layer shown in FIG. 7A, a single slit 701 shown in FIG. 7B, a single hole with a concentric groove 703 shown in FIG. 7C, an array of equally spaced slits shown in FIG. 7D can also be used as the diffraction element 101 of FIGS. 1A and 1B of the present embodiment.

The shape of the individual opening has significant influences on interaction of the metal layer with the light from the light source and thus on the resulting production of plasmon wave on the metal. Accordingly, the resulting diffraction pattern formed on the image sensor is affected by the shape of the individual opening. Therefore, the shape of the openings and the pattern formed thereby in the diffraction element are selected in accordance with the types of the solution and/or target substances as well as the detection accuracy required for the particular solution/target substances of interest.

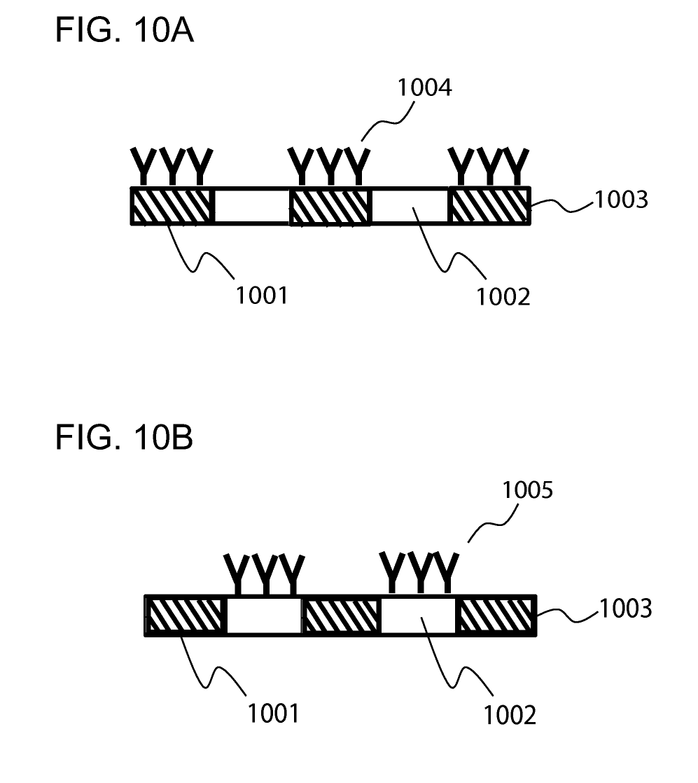

The surface of the diffraction element 101 of FIGS. 1A and 1B can be treated to attach surface-immobilized receptors thereon that will bind the target substance in the solution. When the diffraction element is made of a metal layer with empty openings, the receptors for target or analytes can be formed on the surface of the metal layer using known treatment processes used in the SPR biosensors that utilize surface plasmon resonance in a metal surface, for example, such as Thiol coupling, amine coupling, aldehyde coupling, adsorption, or the like. When the openings are filled with a dielectric, the receptors may be attached to the surface of the dielectric utilizing known treatment processes such as carboxyl derivitization, tosyl activation, amine activation, epoxy activation, adsorption, or any other appropriate binding method. FIG. 10A shows receptors 1004 formed on the surface of the metal 1001 in the diffraction element 1003. FIG. 10B shows receptors 1005 formed on the surface of the dielectric 1002 of the diffraction element 1003. Alternatively, or in addition, receptors may be formed on the bottom of the openings of the diffraction element 101 that expose the top surface of dielectric layer 104 under the metal layer 102.

A non-exhaustive list of analytes to be bound and detected in a sample includes naturally-occurring or synthetic molecules including carbohydrates, proteins, lipids, oligonucleotides, nucleic acids, any organic polymeric materials, inorganic materials, including but not limited to salts, metals, or metal complexes. Exemplary analytes include celluloses, aqueous solutions, deionized water, blood, physiological buffer and other buffers which may also include salts, cerebrospinal fluid, urine, saliva, water, organic solvents, and any combination thereof.

By appropriating choosing a receptor for a given target substance, the device can be configured to measure the presence of the target substance on the detection site of the diffraction element. For example, by appropriating choosing the surface-immobilized receptors, plasma in blood of a patient can be analyzed by the device of the present embodiment so that one or more of the assays in the comprehensive metabolic panel (CMP) assays can be performed. In another example, by appropriately choosing the surface-immobilized receptors and by monitoring the capturing event of the target material over a prescribed period of time, cytometry of blood cells or other biological substances can be conducted using the device of the present embodiment.

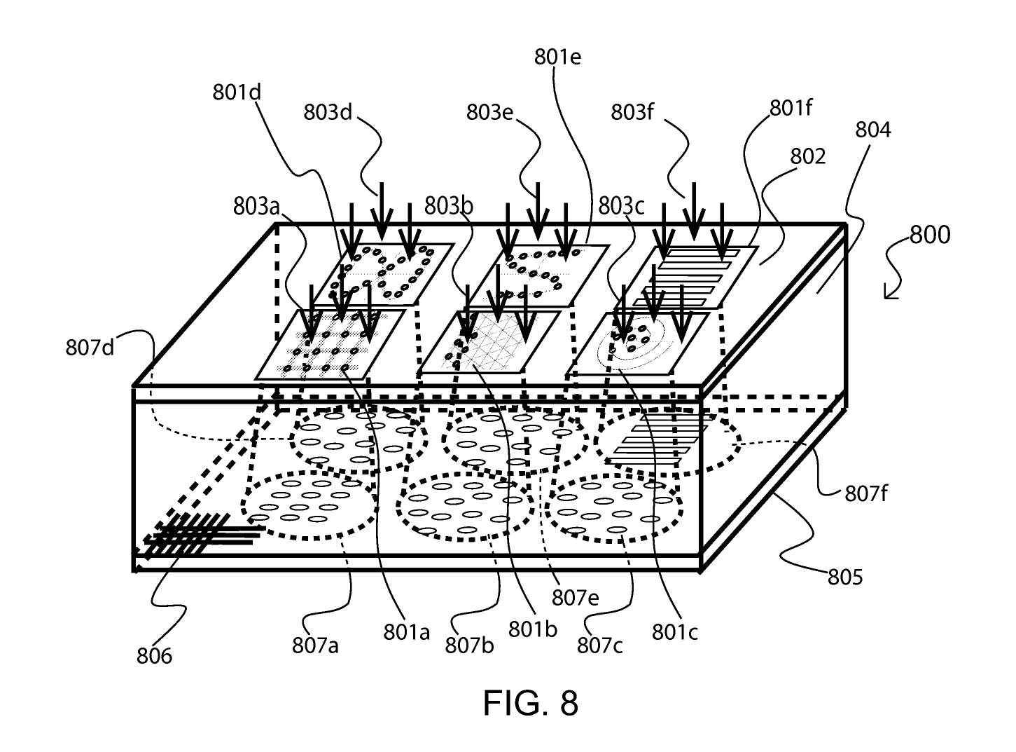

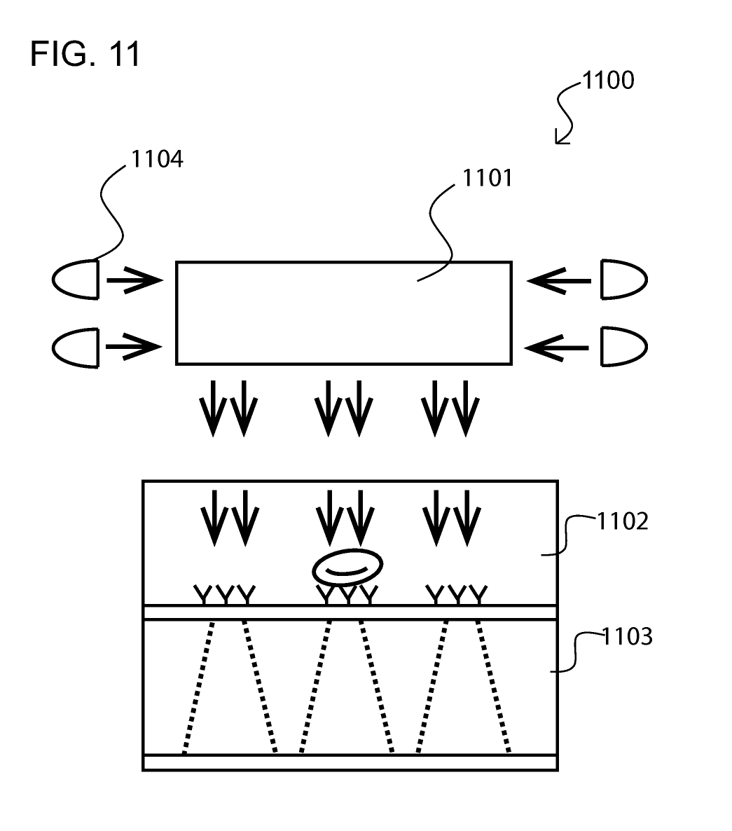

FIG. 8 schematically illustrates another embodiment. The figure shows a multi-detection system 800 for detecting a target substance or substances in a solution contained in a container. The system 800 can include a plurality of diffraction elements with the same or differing patterns, as well as one or more detectors. In FIG. 8, six diffraction elements are integrated as an example. A single container (not shown in FIG. 8; see the container 1102 of FIG. 11) and a single image sensor 805 are shared among the plurality of devices as the container and the image sensor, respectively, of the respective devices. Diffraction elements 801a to 801f having respectively different patterns are formed in a metal layer 802 in this example. A dielectric layer 804 is formed on the image sensor 805 to define the space between the diffraction elements 801a to 801f and the image sensor 805. Light rays 803a to 803f of substantially chromatic light, the primary wavelength of which may be mutually different or the same, are directed to the diffraction elements 801a to 801f, respectively. As a result, diffraction patterns 807a to 807f are formed on the image sensor 805 in respective regions. Pixels 806 of the image sensor 805 have a sufficient density to ensure the detection of changes in the respective diffraction patterns 807a to 807f. The signals from the image sensor 805 can be processed by a processor or a host device connected to the processor to obtain two-dimensional spatial changes in the respective diffraction patterns.

In certain embodiments, an inexpensive CMOS camera chip with unnecessary surface layers removed, if necessary, may be used as the image sensor 805, and the dielectric layer 804 may be formed thereon. The metal layer 802 may then be formed on the dielectric layer 804 by sputtering or vapor evaporation or like method. Diffraction elements 801a to 801f may be formed by an FIB apparatus or other methods as disclosed herein. This way, the dielectric layer 804 and the diffraction elements 801a to 801f may be monolithically integrated with the single image sensor 805.

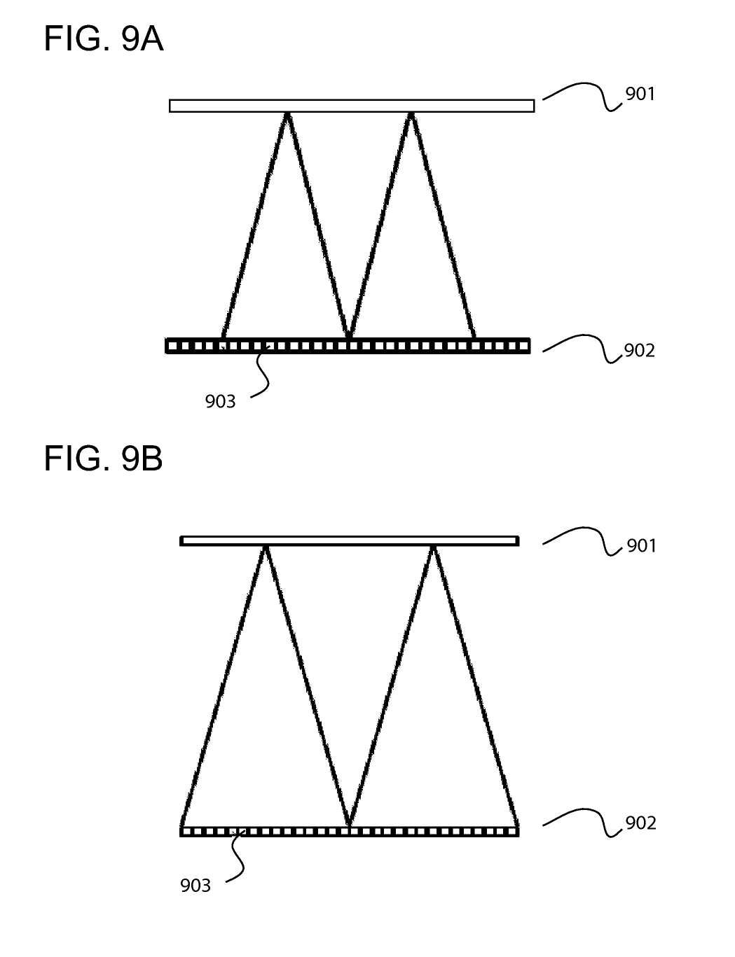

FIGS. 9A and 9B schematically show examples of arrangement of the diffraction elements 801a to 801f relative to the image sensor 805. They show diffraction cones formed by diffracted light from respective diffraction elements in the metal layer 901. As shown in FIG. 9A, when the diffraction patterns diffracted onto the image sensor 902 are relatively small, the spacing between two diffraction elements adjacent to each other can be made relatively small, and the distance from the diffraction elements/metal layer 901 to the image sensor 902 can be made relatively small. In other embodiments, when the divergence angle of the diffracted light that generates a pattern of interest at the sensor is large, the spacing between two diffraction elements adjacent to each other must be made relatively large to avoid crosstalk of adjacent diffraction patterns. The distance from the diffraction elements/metal layer 901 to the image sensor 902 can be decreased to reduce mixing light from adjacent diffraction elements, however this reduces the effective resolution of detection at the sensor. However, if the adjacent diffraction elements generate specific diffraction patterns on the image sensor 902 that can be separated by data processing, an overlap of the imaging areas on the image sensor is acceptable. For example, if the diffraction spots of the two adjacent projected areas on the imaging sensor do not overlap regardless of the presence or absence of the respective target substances, in analyzing one of the diffraction patterns, pixels that are detecting the other diffraction pattern can be ignored. Furthermore, parts of the diffraction patterns of the two adjacent projected areas on the image sensor may overlap, if areas of the diffraction pattern that do not overlap provide sufficient peak shift as to properly characterize the presence absence or partial presence as needed for an application, or if areas of the diffraction pattern that overlap provide sufficient peak shift when deconvolved from each other as to properly characterize the presence absence or partial presence as needed for an application.

FIG. 11 is a side view of an embodiment according to the invention, showing a single shared container 1102, light emitting devices 1104, and an optical system 1101. A plurality of light emitting devices 1104 may be disposed as shown in FIG. 11. An optical system 1101 may be installed to receive light from the respective light emitting devices 1104 and to direct the light rays to the respective detection sites of the diffraction elements similar to 801a to 801f shown in FIG. 8, through a shared container 1102. The optical system 1101 may include lens, prisms, filters, or polarizer and/or optical modulators to process the light from the respective light emitting devices. Alternatively, if single substantially monochromatic light is used, a single light emitting device 1104 may be used, and the light from the light emitting device 1104 may be processed by the optical system 1101 to distribute it among the diffraction elements. A single shared container 1102 is constructed on a metal layer similar to layer 802, shown in FIG. 8, having the diffraction elements similar to 801a to 801f therein. The metal layer 802 is formed on the dielectric layer 1103 under which the image sensor, similar to sensor 805 shown in FIG. 8, is disposed.

The detection sites 801a to 801f (i.e., the diffraction elements 801a to 801f) are treated so that each has surface-immobilized receptors attached thereto for receiving target substances. Each or some of the detection sites may be treated with different chemicals so that they can target different substances. With such a configuration, various types of target substances contained in the solution can be detected simultaneously. For example, some of assays constituting CMP assays may be conducted simultaneously using a system of the present embodiment. Some or all of the detection sites may be treated with the same chemicals so that they can target the same substance with different patterns of the diffraction elements to improve the accuracy of the detection and/or to obtain more detailed positional information of the target substance. With this configuration, positional changes of the target substance over time can be detected and cytometric analysis or the like can be conducted.

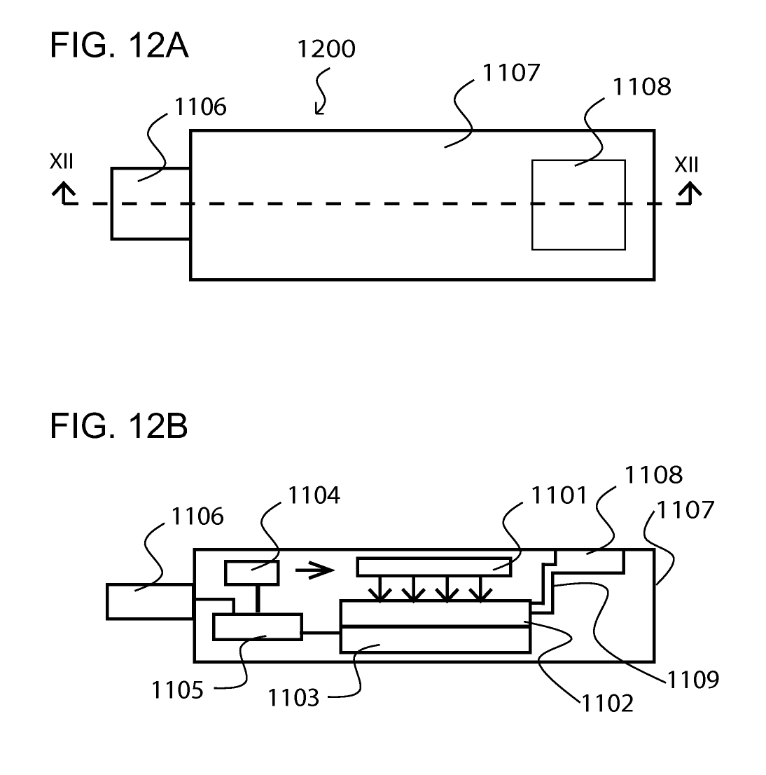

FIGS. 12A and 12B schematically illustrate a portable projected diffraction device 1200. FIG. 12A is a top view of the device and FIG. 12B is a cross-sectional view taken along the line XII-XII of FIG. 12B. The portable device 1200 according to the present embodiment includes a housing 1107 that houses the multi-detection system described above. The housing 1107 has a recess 1108 to receive the solution containing target substances therein, and further has a fluid channel 1109 communicating with the recess and with the single container to transport the solution to the container 1102 of the multi-detection system. A circuit board 1105 is provided in the housing. The circuit board includes a processor to process signals from the image sensor (similar to sensor 805 in FIG. 8) of the multi-detection system. A light source 1104 may include a plurality of light emitting devices 1104 or may include a single light emitting device depending on the needs. A USB Standardplug connector 1106 is provided so that the device can be connected to a host device having a USB port. The connector 1106 is connected to the circuit board to energize the circuit board and the light source 1104 and to exchange data with the host device upon connection to the host device. The overall form factor of the device 1200 may be a generally rectangular shape of a few centimeters by a few centimeters with a thickness of a few millimeters, resembling the shape of typical USB memory sticks, for example. Instead of the USB specifications, other widely used standard specifications or proprietary specifications may be used.

Because of the small and simple, yet reliable detection structure and scheme for detecting refractive index changes that occur as a result of target substance attaching to the surface of the detection area, the multi-detection system may be incorporated into a portable device having a small form factor.

Several modifications are possible and preferable for the configuration of the portable device 1200. For example, the light source 1104 and the optical system 1101 may be installed in a host device to which the portable device 1200 is to be connected, instead of being installed in the device 1100. That is, this portable device includes the recess 1108 (and associated flow channel(s) 1109), the container 1102 and the dielectric layer 1103 (with the diffraction elements and image sensor). The circuit board 1105 may be significantly simplified. A simplified optical system 1101 may be included in the modified portable device 1200. In this case, the top surface of the housing 1107 is equipped with a window that is optically transparent to the light from the light source. When the portable device 1200 is inserted to the host device, an appropriate engaging mechanism may be provided so that the light emitted by the optical system 1101 is aligned with the window on the housing and so that the connector (preferably, specifically designed for this application) securely engages with the reception terminal within the host device. With this configuration, a complex optical system, such as one with modulation mechanism, and a relatively expensive light source, such as a laser device, may be used for the optical system 1101 and the light source 1104, respectively, which are now installed in the host device. This configuration is particularly advantageous when relatively complex optical modulations of the light discussed above are preferred in order to improve the S/N ratio or when a bulky high power laser is preferably used. Furthermore, a powerful processor can be installed in the host device to process data transferred from the portable device to conduct complex pattern recognition algorithms or other appropriate algorithms to determine the changes in the diffraction pattern. In this example, because the portable device 1200 has fewer components, a further miniaturization and cost-reduction are possible for the portable device 1200, making it even more suitable for use as a disposable device.

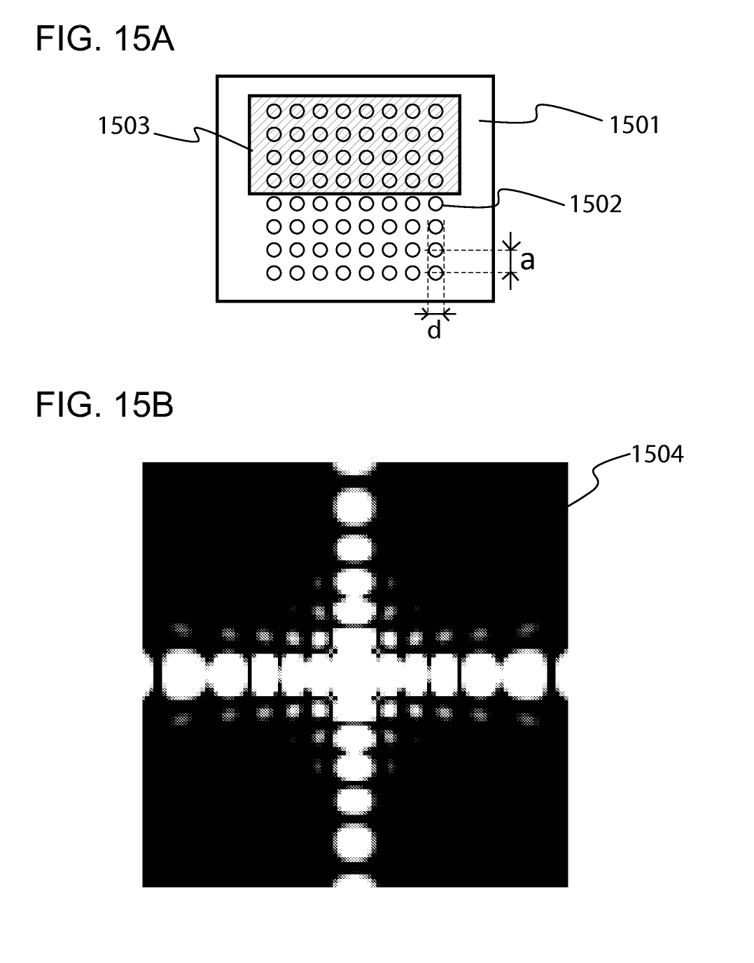

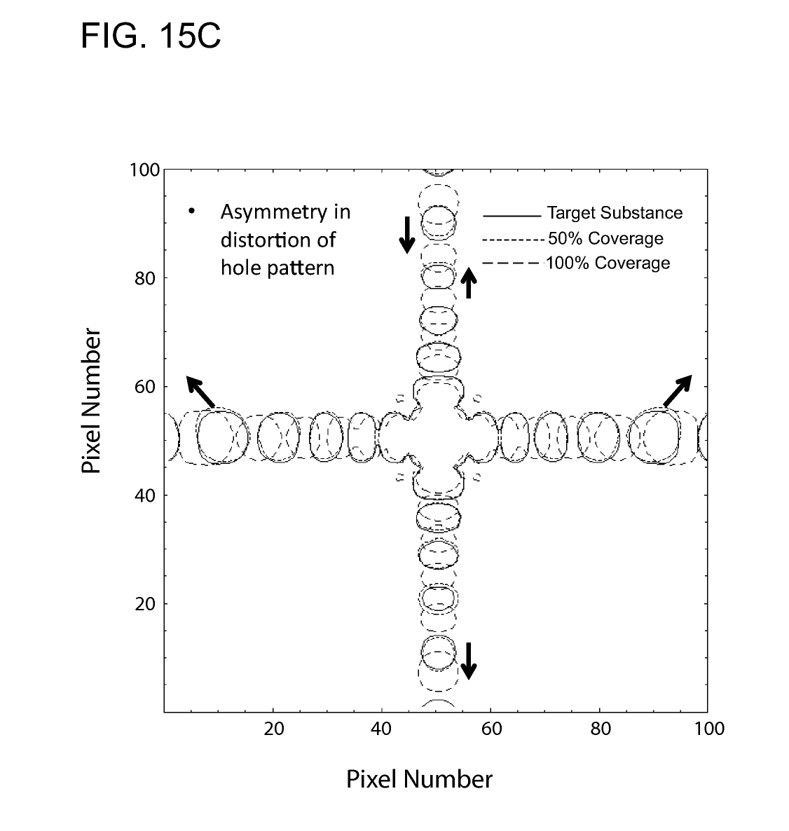

FIGS. 15A and 15B show another embodiment of the diffraction element 1501 and the resulting projected diffraction pattern 1504, respectively, using the same simulation conditions and scheme as those for FIGS. 2A and 2B. As shown in the figures, this diffraction element (detection site) 1501 has 64 (8×8) holes 1502. The diameter d of the holes was set to 300 nm, and the interval a of the holes was set to 500 nm. In this simulation, not only full coverage and total absence of a target substance, but also half coverage of the holes by the target substance as indicated by reference numeral 1503 are simulated. Everywhere surrounding the target substance, including inside all holes, the refractive index was set to 1.33. The refractive index of the target substance was set to 1.50. The target substance is simulated as a rectangular block located 10 nm above the holes. The other parameters are the same as those of the above example as described in FIGS. 2A and 2B.

FIG. 15C shows an intensity contour plot of the diffraction pattern of FIG. 15B. The solid lines indicate equal-intensity counter lines when there is no target substance, and the narrow dash lines indicate the same set of equal-intensity counter lines when half of the holes are obstructed by the target substance (50% coverage), and the wide dash lines indicate the same set of equal-intensity counter lines when all of the holes are obstructed by the target substance (100% coverage). As shown in the plot, many detectable peak shifts are observed across a wide area of the image sensor. Even with the half coverage, the shift in the diffraction pattern is detectable. Furthermore, as shown by the arrows in the figure, certain features of the diffraction pattern move inwardly as the coverage area of the target substance increases from 0 to 50% and 50% to 100%, and other features moves outwardly or in oblique directions. Further, the two-dimensional diffraction pattern change has asymmetry reflecting the direction of the coverage of the target substance over the holes. As seen in FIG. 15C, the top half of the diffraction pattern and its shifts as a result of 50% coverage are different from those of the bottom half. The oblique, upward shift directions of the left and right peripheral features of the diffraction pattern also indicate this directionality. They may be utilized to determine partial coverage of the target substance over the detection area as well as the direction in which the target substance covers the detection area. Thus, the position shifts and shift directions of these multiple features of the diffraction pattern can be utilized to achieve a sensitive and reliable detection of the refractive index change—thus, the presence or absence and partial presence of the target substance.

Various modifications of the embodiments described above and additional or alternative configurations, including some of the features already mentioned above, are described below.

Any of the light sources described above can be an external monochromatic or near monochromatic light source that illuminates the device at normal incidence. In some embodiments, the light source may include monochromatic sources or virtually monochromatic sources such as diode lasers, dye lasers, tunable lasers, gas lasers, frequency doubled lasers, vertical cavity surface emitting lasers (VCSELs), or any other type of laser. In other embodiments, the light source can be near monochromatic, wherein a limited range of wavelengths from a spectrally broader source may be utilized. For example, a source such as a light emitting diode (LED), an organic light emitting diode (OLED), a quantum dot light emitting diode (QLED), a carbon nanotube LED, filament lamp, a low pressure sodium lamp, some discharge lamps, or super luminescent diodes may be used.

In still other embodiments, a broadband source such as sunlight, some discharge lamps such as xenon or deuterium, incandescent lamps, halogen lamps, or white LEDs may be filtered so as to create a substantially monochromatic light source, utilizing one or more filters, gratings, or prisms as needed to select the wavelengths as needed for the application. In some embodiments, a lamp with multiple line spectra such as a mercury arc lamp may be utilized. In a further embodiment, a grating or prism with slits may be utilized, with optional band pass or high or low pass filters to select different input light wavelengths which may be utilized in different areas or regions of the plasmonic filter set.

In a further embodiment, the grating or prism may be manually or automatically adjustable, and a manually or automatically adjustable slit may be provided such that a wavelength and bandpass may be manually or automatically adjusted. In some embodiments, selected wavelengths and band passes may be utilized as part of an automated protocol. In yet further embodiments, a continuous scan over a range of wavelengths may be automatically performed, permitting the generation of a continuous data set of absorption as correlated with time and wavelength. In further embodiments, a dual monochromator with adjustable gratings may be utilized so as to provide for tunable near monochromatic light.

In some embodiments, the intensity of the light source(s) may be varied. In some embodiments, the source may be pulsed or chopped as with an optical chopper. The frequency and duty cycle of the chopped or pulsed light source may be varied for different diffraction elements, or may be varied during the use of one or more diffraction elements for one or more assays, and may be consistent during an assay, or may be varied during an assay.

In some embodiments, a light source may have a particular angle of incidence with respect to the diffraction elements instead of a normal direction as in the embodiments described above. The angle of incidence may be different for different light sources when the system has more than one light source, or may have different particular angles of incidence for different diffraction elements.

In some embodiments, a light source may be configured such that the angle of incidence with respect to the diffraction element may be changed. Said change may be made manually, by rotating a light source and/or a portion of the light path and associated optical elements pivotably about the optical center of the diffraction element, wherein after said rotation, a pin or screw mechanism may be utilized to hold a light source stably in place relative to the diffraction elements. In other embodiments, said rotation may be effectuated in an automated manner, such as by a linear or rotary actuator.

In some embodiments, said rotation of a light source may affect the rotational relationship between the diffraction elements, whilst the angle of incidence may be maintained. The change may be made manually, by rotating a light source and/or a portion of the light path and associated optical elements pivotably about the optical center of the diffraction element, wherein after the rotation, a pin or screw mechanism may be utilized to hold a light source stably in place relative to said plasmonic filter. In other embodiments, said rotation may be effectuated in an automated manner, such as by a linear or rotary actuator. Rotation of a light source may affect both the angle of incidence of the light source with respect to the plasmonic filter, and the rotational relationship between the light source and the plasmonic filter. One or both rotations may be manual or automated, or one may be manual whilst the other is automated.

More than one light source may be utilized, with light intensity of various light sources being adjusted to increase or decrease by use of an optical chopper, by raising and lowering the current to a LED or laser diode, or by the use of a shutter, which may be an electronic shutter, such as an LCD shutter. The sources may be separated by wavelength, such as when different laser diodes are utilized as different sources, or when different filters are used for different or the same light source(s). The sources may be separated by being of different polarizations as described hereinafter. The sources may be separated by having different angles of incidence with respect to the plasmonic filter in one or both axis. Combinations of the above may be utilized such as turning on and off different light sources at different times, which are further separated by having different wavelengths. Any combination of time separation of light sources, spatial separation of light sources, wavelength separation of light sources, polarization separation of light sources, and angles of incidence with respect to the plasmonic filter in one or both axis may be combined.

In still other embodiments, the light source 108 may be turned on and off at different times at different portions of a two dimensional array of plasmonic filters, creating a spatial light pattern. The spatial light pattern may be generated by imaging a two dimensional OLED array onto the two dimensional array of plasmonic filters wherein different elements of the two dimensional array of OLEDs may be modulated individually or in groups or sets so as to create a spatial light pattern at the two dimensional plasmonic filter array. In another embodiment, a two dimensional digital micromirror device (DMD) may be imaged onto the two dimensional array of plasmonic filters by imaging wherein different elements of the two dimensional array of DMDs may be controlled so as to be modulated individually or in groups or sets of light so as to create a spatial light pattern at the two dimensional plasmonic filter array.

The light source may incorporate a filter element to improve light quality or to select a bandpass or set of bandpasses. Various types of filters may be useful for these purposes, including colored glass filters made of an appropriate thickness so as to provide a desired optical filtering level. In an alternative embodiment, a colored filter may be molded as a lens, so that said colored filter may perform both the function of a filter and the function of a lens with a single part. In alternative embodiments, a color filter may be a multilayer dielectric or a rugate filter. Filters may be bandpass, longpass, shortpass, multipass, tunable bandpass, longpass beamsplitter, shortpass beamsplitter, notch beamsplitter, or a multiedge beamsplitter. A dielectric filter may be configured as a transmission filter, as a curved or flat mirror filter, or as a polarizing transmission filter. A dielectric filter may be made with soft coatings, hard coatings or a combination thereof. Color filters may be made of a combination of different technologies, such as a combination of colored glass and dielectric filters, dielectric filters and rugate filters, or any other combinations of filter types. Color filters may be changed utilizing filter wheels or sliders, which may be manual, or may be automated. Light can also be filtered to be circularly or elliptically polarized, linearly polarized with s or p polarization components or a combination thereof, non-polarized, or selectively polarizable, wherein the polarization angle and/or phase of linearly, circularly or elliptically polarized light may be adjusted.

For modulation of the incident light or other purposes, unpolarized light from the light source may be polarized by any of a variety of different types of polarizers, such as a Glan-laser polarizer, a Glan-Tayler polarizer, a Glan-Thompson polarizer, a Lyot polarizer, a Wallaston polarizer, a Rutile polarizer, a line plate polarizer, a polarizing film, a wire grid, a holographic wire grid or any other type of fixed polarizer may be utilized. In some embodiments, the polarization filter or polarization element(s) may be in a part of the optical path wherein the beam may be a collimated beam. In other embodiments, the polarization filter or polarization element may be utilized in a part of the optical path wherein the beam may have a divergence or convergence such that variation in the polarization of the resulting beam does not interfere with the desired interaction with the diffraction element. A quarter wave plate or a quarter wave or rhomb retarder may be utilized to convert linearly polarized light into circularly polarized light. A half, three quarter or full wave nematic liquid crystal variable retarder may be utilized to vary the phase retardation. The liquid crystal variable retarder may be temperature controlled. Continuous phase retardation may be effected using a Solei-Babinet compensator or similar device, which may be manually adjusted, or may utilize a motorized actuator.

In some embodiments, multiple types of polarization may be utilized. In some embodiments, different sources may have different wavelengths, different polarizations, different polarization phase angles with respect to each other, or different magnitudes with respect to each other or combinations of any of the above. In some embodiments, polarization may be changed, for example, the polarization of a single source may be switched from being linearly polarized to being circularly polarized, or may be switched from having s linear polarization to having p linear polarization. The polarization of a source may interact differently with different diffraction elements, such that changing the polarization may result in effectively turning off the excitation of one set of diffraction elements, and turning on another set, wherein the different sets of diffraction elements may have different moieties (that surface-immobilized receptors can receive) associated thereto, and thus a single source may be able to separately measure different moieties, which may otherwise be spaced such that they are optically indistinguishable. A collimation element may be required if light from light source is not sufficiently collimated. Use of a collimation element may be preferred when the light source is an LED or a laser diode. A LED collimator may comprise, at least in part, a reflector. In some embodiments, a LED collimator may at least in part comprise an aspheric or Fresnel lens or lens system. In some embodiments, a laser collimator may also comprise a beam expander such as a 5X or 10X beam expander.

In some embodiments, the solution may be introduced on the sensor side of the diffraction element. In this case, incident light would interact first with the diffraction element, then the solution, before being detected by the image sensor. Changes in the diffraction patterns produced in these embodiments would be detectable in the same manner as described previously. Additional scattering at the solution/camera interface may occur with this arrangement, though scattering at the light source/solution interface is eliminated. The noise reduction techniques described above or those known in the art may be employed to improve the S/N ratio.

As will be understood, filters, collimators, light guides or other intermediary optical components may be constructed using commercially available glasses or polymers. Specialty glasses may be required for certain embodiments requiring transmission of ultraviolet wavelengths. This is particularly true for when it is desirable to use wavelengths between 260 nm and 400 nm, and wherein it may be desirable to utilize transmissive optical elements. In other embodiments, a glass such as a zinc barium silicate glass or a borosilicate float glass may be utilized. In further embodiments, wherein a desired wavelength may be 350 nm or more, a standard soda lime glass may be utilized.

In some embodiments, it may be desirable to utilize reflective optics rather than refractive optics, particularly when the desired wavelength is below 350 nm, and even more particularly when the desired wavelength is below 300 nm. Thus any focusing optics and/or filters may be configured as mirrors rather than as transmissive elements, so as to prevent the need (and cost) of fused silica. In other embodiments, fused silica may be utilized for transmissive elements. The diffraction element can include a structurally patterned metal film composed in whole or in part of gold, silver, copper, aluminum, or alloys thereof, as well as any other suitable conductive and reflective materials. Multiple different metals or metal alloys may be utilized in different areas of the plasmonic filter elements. Metamaterials such as aligned microwires, such as aligned silver, aluminum or gold nanowires may be utilized, and may be further formed into plasmonic filter elements. Other materials such as those considered to be dielectrics may be utilized either with or without metals.

The diffraction elements may have a compact mosaic, loose tile pattern, a rectangular or other grid layout, or circular, arcuate, spiral, or other desired geometric shape. Each diffraction element may have nanoscale patterning of metallic and dielectric shapes that selectively inhibit or promote transmission of various wavelengths of light therethrough. In certain embodiments, the diffraction element can be formed from holes (including arrays of holes) in a metal film, by scattering occlusions in transparent films, apertures filled with a transparent dielectric in a metal film, or dielectric particles in a regular or irregular distribution on a surface. The apertures or holes in a metal film may completely penetrate the metal film, or may partly penetrate the metal film, or some apertures or holes may fully penetrate the metal film, and other apertures or holes may partially penetrate the metal film. These plasmonic structures, which can include upraised structures, islands, and open or dielectric filled apertures, may be configured such that the incident light may be resonant with at least one plasmon mode on the surface of the structures in said metal film or metal islands, and the metallic plasmonic structures provide surface plasmon energy resonance bands for the wavelength selective transmission of light. In alternate embodiments, concentration of electromagnetic fields in a surface plasmonic process could be used to enhance intensity-dependent processes such as upconversion or two photon events.

The diffraction elements may include one or more array patterns, with each array pattern being defined with the design rule which determines the long range order of the filter. The array may be periodic, aperiodic, quasi-periodic, and may be laid out in one, two, or three dimensions. The periodicity may be different in the different dimensions or in different layers for multilayer embodiments. The array pattern primarily determines the surface wave interference properties, and secondarily influences the scattering and coupling behavior of neighboring elements through mutual electromagnetic dipole interaction. The motif describes the detailed geometry of the constituent elements in the array. The shape and material composition of the motif elements primarily determine the optical scattering spectrum and strength. Examples of motif elements include holes (including arrays of holes) in a metal film, scattering occlusions in transparent films, complex apertures such as coaxial holes, and dielectric or metal particles in a regular or irregular distribution on a surface.

Radial symmetries utilizing any of the aforementioned apertures or combinations thereof may be utilized. The combinations may be configured to provide a single effective wavelength with greater sensitivity, or may be configured to provide multiple wavelengths to be associated with a single “micro spectrometer”, or a combination thereof may be utilized.

In some embodiments, a motif or feature of the diffraction element will be characterized by a complete removal of material from some fraction of the plane (binary motifs) whereas in other embodiments a motif may describe a more complex pattern with varying thickness or composition. In some embodiments, a motif or feature of the diffraction element may be a circular aperture from which material is removed completely, or a motif may be a circular aperture from which material is removed incrementally in order to form an inverted cone structure. Motifs can therefore be described by a two dimensional function f(x,y) corresponding to the process conditions at each point. For example, a function may correspond to the fractional removal of material, the fractional overcoating of material with a second material, the fractional implantation of a material with a dopant or other modifying material, or the variation in porosity of a material.

The image sensors that can be used include any focal plane array (FPA) device, including a front or back illuminated charge-coupled device (CCD), a photon penetration depth dependent, a photo-diode array (PDA), an avalanche photodiode (APD) array, a PMT array, or a front or back illuminated complementary metal-oxide semiconductor (CMOS) detector. For low cost embodiments, as described above, consumer CMOS detectors can be used with suitable modifications. Preferably, such detectors will have a pixel count in excess of the number of diffraction elements in a multi-detection system described above, and may be a multiple of the number of diffraction elements, such as 10 times, 100 times, or 1000 times as many pixels as diffraction elements, with a sensor area quantum efficiency of from 10% to 90% depending on wavelength and whether the detector is a front side illuminated or backside illuminated device, a read noise of from 0.2 to 40, or 1 to 10, or 2 to 6 electrons, and read-out speed of from 1 to 1000, or from 10 to 100 full frames per second. Alternatively, a CCD chip can be used for applications requiring greater count accuracy, quantum yield, and binning flexibility. The sensor may be cooled or temperature stabilized. The sensor may be a monolithic sensor, or may be a hybrid sensor with different sections of the sensor utilizing different materials (such as silicon, InGaAs, HgCdTe), such that the different sections may have different wavelength quantum efficiencies, or the sensor may be a sensor assembly wherein multiple sensor chips may be integrated into a single sensor, which may be effectuated utilizing a PCB or hybrid assembly. Monochrome detectors can be used, or alternatively, detectors with conventional Bayer filters or other custom absorption, dielectric or polarization filters can be used.

In some embodiments, the image sensor may utilize 10 bit data acquisition, or may utilize an A/D converter with higher sensitivity, such as a 12 bit, 14 bit or 16 bit A/D converter. In other embodiments, a sensor may be utilized which utilizes an electron multiplying CCD sensor, which may have a read noise of less than one photoelectrons.

In some embodiments wherein a CMOS image sensor is utilized, and a maximum image throughput (maximum frame rate) is desired, a rolling shutter readout of the CMOS sensor may be performed. In other embodiments, wherein a CMOS image sensor is utilized and it is desired that readout of different portions be very well synchronized with each other, a global readout of the CMOS sensor may be performed.

In some embodiments, a separate photodiode reference may be utilized in addition to the “main” image sensor. Said diode may be utilized as a reference level in order to set the effective input power level, either by setting the “main” sensor integration time, or by setting the size of one or more of the input apertures for a sunlight input system, or by setting the power level of a LED, laser, or other power supply, or a combination of setting the integration time/aperture and or light source power level.

In some embodiments, to minimize the thickness of the device, the plasmonic structure may be directly fabricated on top of a CMOS sensor with a flat transparent spacer/protective layer in between. The advantage of such a system is that the exact distance between the plasmonic structure and the detector surface can be precisely controlled by defining the deposition thickness of the transparent spacer via magnetron sputtering or plasma enhanced chemical vapor deposition (PECVD) or pulsed laser deposition. This enables accurate determination of the magnification factor and the conversion between the detected diffraction pattern image and the scattering angular distribution. The spacer thickness may be thick enough such that there may be sufficient magnification of the diffraction pattern on the sensor surface.

In some embodiments, a single diffraction feature (peaks, troughs or inflection points) may have a spatial extent of several detector pixels so that sub-pixel averaging is possible for high sensitivity tracking of pattern changes. However, the separation between the diffraction element and the detector cannot be too large otherwise the sensitivity of nearby sensing regions will be reduced due to cross-talk (in this case, large angle diffraction from one sensing region may be detected by an adjacent region).

In some embodiments, additional micro-lenses (˜100 microns or smaller) can be integrated with the detection sensor or with the output surface of the diffraction element to increase the angular spread of the diffraction pattern for enhanced resolution (higher angular magnification) or reduce the angular spread of the diffraction pattern to minimize cross-talk between adjacent sensors for higher integration density. For example, by placing a total internal reflection lens (TIR lens) over the output surface of the diffraction element, large angle scattering will be reflected towards the normal direction, thus eliminating their interference with adjacent sensor regions, enabling high-density integration of sensing regions while conserving the total number of diffraction features for parallel information. Other dielectric optical elements may be inserted between the diffraction element and the detector to engineer the scattering angular distribution from the diffraction element. Filtering of the scattering angular distribution can also be accomplished by a secondary plasmonic filter alone or in combination with a lens or aperture which may serve to block one or more of the orders of the spectrum which may be transmitted by said plasmonic filter. In some embodiments, it may be particularly desirable to block zero order light, as it may not have appropriate spectral dispersion. In some embodiments, more light may be present in zero order than in first order light, potentially causing saturation of a sensor. It may further be desirable to block second order or higher light, while passing first order light. Such a block may be a physical aperture.

In operation, differences in refractive index in the immediate vicinity of a diffraction element are measured. The change in refractive index may result from changes in the refractive index of the bulk solution, or may result from binding events, particularly binding events which occur between moieties in solution and moieties bound to or immediately adjacent to the diffraction element (i.e., surface-immobilized receptors). For purposes herein, immediately adjacent or vicinity may mean within a distance equal to two times the wavelength of light. Binding may change the refractive index of the area in the immediate vicinity of a plasmonic filter element. Binding can include various chemical or biological molecules of diagnostic interest, including but not limited to antigen antibody binding, DNA hybridization, RNA DNA hybridization, aptamer binding, binding of organic molecules or metals, binding of a protein or enzyme to a DNA or RNA molecule, or the formation of a self-assembled monolayer.

The detection mode conducted by the processor or the host device connected to the processor may include the steps of identifying intensity peaks in the diffraction image, locating them relative to the camera pixel positions, and tracking any motion of such peaks (for example, in i, j pixel space) actuated by the presence/absence of analyte. Assuming that the typical size of these peaks is about 1/10 of the total image size or smaller, the device may be tracking features that may be only a few times the size of a camera pixel. Software processing may be employed to achieve enhanced subpixel resolution through peak fitting or other suitable image processing techniques. Efficient autocorrelation may also be performed by processing in the frequency domain using Fourier transform techniques. In particular, autocorrelation may be combined with an optimization over a subpixel image shift parameter controlling a linear varying phase term applied to the frequency representation of the image prior to multiplication in the frequency domain.

Due to the mode of operation of this device, in some embodiments, the detection may be made relatively insensitive to variation in the source power. In an alternate implementation, the illumination could be several independent monochromatic coherent light sources. Multiple color channels provide extra data, which increases the overall selectivity of the device. Advantageously, this type of implementation may take advantage of color detectors having a conventional Bayer filter pattern. In addition, plasmonic surfaces can be designed to generate distinct diffraction response at each illumination color and multi-color channel data analysis can be used to improve effective detection sensitivity.

In some embodiments, it may be desirable to utilize a light conversion element such as a phosphor in association with a light source, for example to “downshift” light energy to a wavelength which may be readily absorbed by an imaging sensor. For example, lumogen may be utilized to “downshift” or red-shift UV light which may not be well absorbed by a standard CCD or CMOS sensor. Other materials such as coronene, Ce³⁺—Tb³⁺ coactivated ZnAl₂O₄, KCaGd(PO₄)₂:Eu³⁺ and various other phosphors may be utilized. In some embodiments, the phosphor may be associated with the sensor, in some embodiments being coated thereon.

It will be apparent to those skilled in the art that various modifications and variations can be made without departing from the spirit or scope of the invention. Thus, it is intended that the disclosed embodiments cover modifications and variations that come within the scope of the claims that eventually issue in a patent(s) originating from this application and their equivalents. In particular, it is explicitly contemplated that any part or whole of any two or more of the embodiments and their modifications described above can be combined in whole or in part.

What is claimed is:

1. A device for detecting a target substance in a solution, comprising:
a light source that emits substantially monochromatic light;
a container configured to contain a solution that contains one or more types of target substances, said solution having a refractive index different from a refractive index of said one or more types of target substances;
a substantially planar diffraction element optically coupled to the light source to receive the light originating from the light source, the diffraction element having a top surface and a bottom surface and having one or more of openings that are empty or filled with a dielectric, wherein said openings generate plasmon waves upon receipt of the light from the light source, the top surface of the diffraction element being configured to interact with the solution in the container and configured to attach surface-immobilized receptors in the vicinity thereon that will bind said one or more types of target substances in the solution so that a change in refractive index occurs in the vicinity of said top surface when the target substance binds to said surface immobilized receptors;
a two-dimensional image sensor disposed under the diffraction element to detect a diffraction pattern projected onto the image sensor by the light from the light source that has interacted with the diffraction element, the image sensor having a plurality of pixels to detect the diffraction pattern; and
a processor connected to the two dimensional image sensor to process signals outputted from the sensor for determining the presence of the target substance on the diffraction element,
wherein the diffraction element and the image sensor are configured and arranged such that, upon receipt of the light from the light source, the plasmon waves are generated on the diffraction element so as to generate the diffraction pattern that includes a plurality of distinct diffraction spots or lines on the image sensor, positions of the plurality of distinct diffraction spots or lines on the image sensor being dependent on the refractive index in the vicinity of the top surface of the diffraction element.

2. The device according to claim 1, wherein the diffraction element and the image sensor are configured and arranged such that said change in refractive index that occurs when the target substance binds to surface immobilized receptors in the vicinity of the diffraction element causes at least one of the plurality of diffraction spots or lines to shift its position by a distance greater than a pitch of the pixels.

3. The device according to claim 1, wherein the device is configured to detect a single target substance and the processor uses a single threshold to determine the presence or absence of the target substance in the vicinity of the diffraction element in processing signals from the image sensor.

4. The device according to claim 1, wherein the processor processes the signals from the image sensor to detect a pattern formed by at least some of the plurality of distinct diffraction spots or lines, and determines the presence or absence of the target substance in accordance with a two-dimensional spatial change in the pattern.

5. The device according to claim 1, wherein the processor uses a subpixel interpolation algorithm to determine two-dimensional coordinates representing a position of at least one of the plurality of distinct diffraction spots or lines.

6. The device according to claim 1, wherein the processor uses a subpixel interpolation algorithm to determine two-dimensional coordinates representing respective peak positions of the plurality of distinct diffraction spots or lines at a resolution greater than a resolution of the image sensor, and detects a pattern formed by the determined peak positions of the plurality of distinct diffraction spots or lines using a pattern recognition algorithm, and
wherein the processor determines the presence or absence of the target substance in accordance with a two-dimensional spatial change in the pattern.

7. The device according to claim 1, wherein the diffraction element has a detection site defined by a two-dimensional area on the top surface thereof that includes said one or more of openings and vicinity thereof, and
wherein when the target substance covers only partially the detection site of the diffraction element, the processor processes the signals from the image sensor to determine an area or volume percentage at which the target substance occupies the detection site.

8. The device according to claim 1, wherein the light emitted from the light source is directed to the container so that the light passes through the container containing solution prior to interact with the diffraction element.

9. The device according to claim 1, further comprising an optical modulator that modulates at least one of phase, polarization, and intensity of the light emitted from the light source, wherein the processor demodulates the signals from the image sensor to improve a signal-to-noise ratio.

10. The device according to claim 1, further comprising a polarizer to polarize the light emitted from the light source so that the light impinging upon the top surface of the diffraction element is linearly polarized.

11. The device according to claim 1, further comprising a dielectric layer integrally formed on the image sensor, wherein the diffraction element is disposed on the dielectric layer, the dielectric layer defining a spatial relationship between the diffraction element and the image sensor.

12. The device according to claim 1, wherein the diffraction element is made of aluminum, copper, or one of noble metals that include ruthenium, rhodium, palladium, silver, osmium, iridium, platinum, and gold, or any alloy thereof.

13. The device according to claim 1, wherein the diffraction element is made of a metal and the opening is filled with a dielectric.

14. The device according to claim 13, wherein the surface-immobilized receptors are attached to a surface of the metal.

15. The device according to claim 1, wherein the surface immobilized receptors are attached to a surface of a dielectric in the vicinity of the top surface of the diffraction element.

16. The device according to claim 1, wherein the diffraction element has a periodic array of a plurality of the openings.

17. The device according to claim 16, wherein a dimension of the opening and a pitch of the periodic array are both shorter than a primary wavelength of the substantially monochromatic light from the light source in vacuum.

18. The device according to claim 1, wherein the light source includes an LED.

19. The device according to claim 1, further comprising a light conversion element that converts light from the light source to light having a wavelength detectable by the image sensor.

20. The device according to claim 1, wherein the light source emits another substantially monochromatic light, and the processor processes signals from the image sensor representing the diffraction pattern generated by said another substantially monochromatic light to improve detection accuracy.

21. A multi-detection system for detecting a target substance or substances in a solution comprising:
a plurality of the devices as set forth in claim 1,
wherein a single container and a single image sensor are shared among the plurality of the devices as the container and the image sensor, respectively, of the respective devices.

22. The device according to claim 21, further comprising a dielectric layer integrally formed on the image sensor,
wherein the diffraction elements are disposed on the dielectric layer, and the dielectric layer defines a spatial relationship between the diffraction elements and the image sensor, and
wherein the dielectric layer and the diffraction elements are monolithically integrated with the single image sensor.

23. The system according to claim 21, wherein a single light source is shared among the plurality of the devices as the light sources of the respective devices.

24. The system according to claim 21, wherein at least some of the lights sources of the plurality of devices are different from each other, emitting light of different wavelengths.

25. The system according to claim 21, wherein at least some of the diffraction elements of the plurality of devices have patterns of the openings that are mutually different.

26. The device according to claim 1, wherein the light source is coherent.

27. The device according to claim 1, wherein the light emitted by the light source is collimated.

28. The device according to claim 1, wherein the top surface of the diffraction element is configured to attach biorecognition elements capable of interaction with chemical and/or biological species as the surface-immobilized receptors.

29. The device according to claim 1, wherein the diffraction element comprises periodically arranged transparent apertures in a metal film, said apertures being filled with a dielectric transparent to the light from the light source.

30. The device according to claim 1, wherein the light from the light source is polarized, and the diffraction element comprises periodically arranged transparent apertures in a metal film, with apertures having a symmetry selected to differentially respond to the polarized light.

31. The device according to claim 1, wherein the diffraction pattern on the image sensor has a central peak and multiple secondary peaks that together are measured to define a two dimensional position of the central peak.

32. A device for detecting an analyte, comprising:
a light source emitting substantially monochromatic light;
a two-dimensional diffraction element that interacts with the light from the light source, the diffraction element having one or more of features that can generate plasmon waves upon receipt of the light from the light source, at least some of the features being configured to interact with the analyte; and
a two-dimensional image sensor configured to receive diffracted light from the diffraction element so as to detect a diffraction pattern projected thereto and to measure a two-dimensional spatial change in the diffraction pattern that occurs as a result of the analyte interacting with the feature of the diffraction element.

33. A method for detecting an analyte, comprising:
emitting substantially monochromatic light;
diffracting said light with a two-dimensional diffraction element, said light being coupled to one or more of features of the diffraction element to generate plasmon waves;
causing at least a portion of the diffraction element to interact with an analyte; and
detecting a diffraction pattern projected by the diffracted light on a two-dimensional image sensor and measuring a two-dimensional spatial change in the diffraction pattern on the image sensor that occurs as a result of the analyte interacting with the feature of the diffraction element.

34. The method according to claim 33, wherein the diffraction element transmits the emitted light to project the diffraction pattern onto the image sensor.

35. The method according to claim 33, wherein the diffraction element reflects the emitted light to project the diffraction pattern onto the image sensor.

36. A portable projected diffraction device, comprising:
a housing enclosing the multi-detection system as set forth in claim 21, the housing having a recess to receive the solution containing target substances therein, the housing further having a fluid channel communicating with the recess and with the single container to transport the solution to the container;
a circuit board housed by the housing, the circuit board including a processor shared among the plurality of devices as the processor of respective one of the plurality of devices;
one or more of light emitting devices and an optical system optically coupled to said one or more of light emitting devices as the light sources of the plurality of devices; and
a connector configured to be connected to a host device, the connector being connected to the circuit board for energizing the circuit board and for exchanging data with the host device.

37. The portable projected diffraction device according to claim 36, wherein the housing and the connector meet the specifications of the USB standards so that the device can be connected to a standard USB port of a computer.

38. The portable projected diffraction device according to claim 37, wherein the circuit board processes the signals from the image sensor and transmits the processed data to the host device when connected so that the host device can determine the presence or absence of the target substances on the respective diffraction elements in accordance with the received data.

39. A method of manufacturing a device that detects a target material in a solution, the method comprising:
depositing a dielectric layer on an array of photodetectors constituting a two-dimensional image sensor;
forming a metal layer on the dielectric layer;
forming a diffraction element in the metal layer;
forming an enclosure on the diffraction element for containing the solution that includes the target, the enclosure being configured so that the diffraction element interacts with the solution when the enclosure is filled with the solution; and
providing a light source that emits substantially monochromatic light optically coupled to the diffraction element,
wherein the diffraction element has one or more of features that can generate plasmon waves upon receipt of the light form the light source, at least some of the features being configured to interact with the target substance, and
wherein the two-dimensional image sensor receives diffracted light from the diffraction element so as to detect a diffraction pattern projected thereto and to measure a two-dimensional spatial change in the diffraction pattern that occurs as a result of the substance interacting with the feature of the diffraction element.

40. A portable projected diffraction unit to be attached to a host device that has an external light source, the unit comprising:
a housing with a connector for connecting the unit to the host device;
a container housed by said housing, configured to contain a solution that contains one or more types of target substances, said solution having a refractive index different from a refractive index of said one or more types of target substances;
a plurality of substantially planar diffraction elements housed by said housing, each of the diffraction elements being configured to be optically coupled to the external light source in the host device to receive light originating from the external light source when connected to the host device, each of the diffraction elements having a top surface and a bottom surface and having one or more of openings that are empty or filled with a dielectric, wherein said openings generate plasmon waves upon receipt of the light from the external light source, the top surface of each of the diffraction elements being configured to interact with the solution in the container and configured to attach surface-immobilized receptors in the vicinity thereon that will bind said one or more types of target substances in the solution so that a change in refractive index occurs in the vicinity of said top surface when the target substance binds to said surface-immobilized receptors;
a two-dimensional image sensor housed by said housing and disposed under the plurality of diffraction elements to detect respective diffraction patterns projected onto the image sensor by the light that has interacted with the diffraction elements, the image sensor having a plurality of pixels to detect the diffraction patterns; and
a circuit board connected to the two dimensional image sensor to process signals outputted from the sensor to transmit the processed signals to the host device through the connector when the unit is connected to the host device, so that the host device can further process the signals,
wherein said housing has a recess to receive the solution containing the target substances therein, the housing further having a fluid channel communicating with the recess and with the single container to transport the solution to the container.

41. The unit according to claim 41, wherein the diffraction elements and the image sensor are configured and arranged such that, upon receipt of the light from the external light source, the plasmon waves are generated on the diffraction elements so as to generate the respective diffraction patterns at least some of which includes a plurality of distinct diffraction spots or lines on the image sensor, properties of which are dependent on the refractive index in the vicinity of the top surface of the diffraction element.

42. The device according to claim 1, wherein the processor processes the signals from the image sensor to detect a pattern formed by at least some of the plurality of distinct diffraction spots or lines, and determines the presence or absence of the target substance in accordance with a change in relative positions among said at least some of the plurality of distinct diffraction spots or lines that form the detected pattern.

43. The device according to claim 32, wherein the two-dimensional image sensor identifies two or more features in the diffraction pattern and measures a change in relative positions among said two or more features that occurs as a result of the analyte interacting with the feature of the diffraction element.

44. The device according to claim 1, wherein the diffraction element and the light source are configured such that the plurality of distinct diffraction spots or lines change their relative positions anisotropically in response to a change in the refractive index on the diffraction element.

45. The device according to claim 44, wherein a pattern formed by the plurality of distinct diffraction spots or lines contracts or expands in response to the change in the refractive index on the diffraction element, the contraction/expansion ratio thereof being different between a first axis and a second axis that is different from the first axis on the image sensor

46. The device according to claim 32, wherein said two-dimensional spatial change in the diffraction pattern is anisotropic.

47. The device according to claim 46, wherein an amount of said two-dimensional spatial change along a first axis differs from an amount of said two-dimensional spatial change along a second axis that is different from the first axis.

48. The device according to claim 1,
wherein the diffraction element and the image sensor are configured and arranged such that when the target substance partially covers the diffraction element, the diffraction pattern exhibits asymmetrical positional shifts, and
wherein the processor determines the partial coverage of the diffraction element by the target substance based on said symmetrical positional shifts.

49. The device according to claim 48,
wherein the asymmetrical shifts include positional shifts of at least some of the distinct diffraction spots or lines in directions that are substantially opposite to each other.
